(19) United States
(12) Patent Application Publication
(10) Pub. No.: US 2008/0082295 A1
(43) Pub. Date: Apr. 3, 2008

(54) ABNORMAL SITUATION PREVENTION IN A COKER HEATER

(75) Inventors: Ravi KANT, Savage, MN (US); John Philip Miller, Eden Prairie, MN (US); Joseph H. Sharpe, Glen Allen, VA (US); Tautho Hai Nguyen, Brooklyn Park, MN (US)

Correspondence Address: MARSHALL, GERSTEIN & BORUN LLP (FISHER), 233 SOUTH WACKER DRIVE, 6300 SEARS TOWER, CHICAGO, IL, 60606, US

(73) Assignee: FISHER-ROSEMOUNT SYSTEMS, INC., Austin, TX (US)

(21) Appl. No.: 11/864,695

(22) Filed: Sep. 28, 2007

Related U.S. Application Data
(60) Provisional application No. 60/847,866, filed on Sep. 28, 2006.

(51) Int. Cl. G06F 17/18; G06F 15/00; G06G 7/48

(52) U.S. Cl. 702/179; 702/183; 703/9

(57) ABSTRACT

A system and method to facilitate the monitoring and diagnosis of a process control system and any elements thereof is disclosed with a specific premise of abnormal situation prevention in a coker heater of a coker unit in a product refining process. Monitoring and diagnosis of faults in a coker heater includes statistical analysis techniques, such as regression. In particular, on-line process data is collected from an operating coker heater in a coker area of a refinery. A statistical analysis is used to develop a regression model of the process. The output may use a variety of parameters from the model and may include normalized process variables based on the training data, and process variable limits or model components. Each of the outputs may be used to generate visualizations for process monitoring and diagnostics and perform alarm diagnostics to detect abnormal situations in the process.

### RELATED APPLICATIONS

This application claims priority from U.S. Provisional Application Ser. No. 60/847,866, which was filed on Sep. 28, 2006, entitled “Abnormal Situation Prevention in a Fired Heater” the entire contents of which are expressly incorporated by reference herein.

### TECHNICAL FIELD

This disclosure relates generally to abnormal situation prevention in process control equipment and, more particularly, to abnormal situation prevention in a refinery coker heater.

### DESCRIPTION OF THE RELATED ART

Process control systems, like those used in chemical, petroleum or other processes, typically include one or more centralized or decentralized process controllers communicatively coupled to at least one host or operator workstation. The process controllers are also typically coupled to one or more process control and instrumentation devices such as, for example, field devices, via analog, digital or combined analog/digital buses. Field devices, which may be valves, valve positioners, switches, transmitters, and sensors (e.g., temperature, pressure, and flow rate sensors), are located within the process plant environment and perform functions within the process such as opening or closing valves, measuring process parameters, increasing or decreasing fluid flow, etc. Smart field devices such as field devices conforming to the well-known FOUNDATION™ Fieldbus (hereinafter “Fieldbus”) protocol or the HART® protocol may also perform control calculations, alarming functions, and other control functions commonly implemented within the process controller.

The process controllers, which are typically located within the process plant environment, receive signals indicative of process measurements or process variables made by or associated with the field devices and/or other information pertaining to the field devices, and execute controller applications. The controller applications implement, for example, different control modules that make process control decisions, generate control signals based on the received information, and coordinate with the control modules or blocks being performed in the field devices such as HART and Fieldbus field devices. The control modules in the process controllers send the control signals over the communication lines or signal paths to the field devices to thereby control the operation of the process.

Information from the field devices and the process controllers is typically made available to one or more other hardware devices such as operator workstations, maintenance workstations, personal computers, handheld devices, data historians, report generators, centralized databases, etc., to enable an operator or a maintenance person to perform desired functions with respect to the process such as, for example, changing settings of the process control routine, modifying the operation of the control modules within the process controllers or the smart field devices, viewing the current state of the process or of particular devices within the process plant, viewing alarms generated by field devices and process controllers, simulating the operation of the process for the purpose of training personnel or testing the process control software, and diagnosing problems or hardware failures within the process plant.

While a typical process plant has many process control and instrumentation devices such as valves, transmitters, sensors, etc. connected to one or more process controllers, there are many other supporting devices that are also necessary for or related to process operation. These additional devices include, for example, power supply equipment, power generation and distribution equipment, rotating equipment such as turbines, motors, etc., which are located at numerous places in a typical plant. While this additional equipment does not necessarily create or use process variables and, in many instances, is not controlled or even coupled to a process controller for the purpose of affecting the process operation, this equipment is nevertheless important to, and ultimately necessary for proper operation of the process.

As is known, problems frequently arise within a process plant environment, especially within a process plant having a large number of field devices and supporting equipment. These problems may be broken or malfunctioning devices, logic elements, such as software routines, residing in improper modes, process control loops being improperly tuned, one or more failures in communications between devices within the process plant, etc. These and other problems, while numerous in nature, generally result in the process operating in an abnormal state (i.e., the process plant being in an abnormal situation) which is usually associated with suboptimal performance of the process plant.

Many diagnostic tools and applications have been developed to detect and determine the cause of problems within a process plant and to assist an operator or a maintenance person to diagnose and correct the problems, once the problems have occurred and have been detected. For example, operator workstations, which are typically connected to the process controllers through communication connections such as a direct or wireless bus, Ethernet, modem, phone line, and the like, have processors and memories that are adapted to run software, such as the DeltaV™ and Ovation® control systems, sold by Emerson Process Management. These control systems have numerous control module and control loop diagnostic tools. Maintenance workstations may be communicatively connected to the process control devices via object linking and embedding (OLE) for process control (OPC) connections, handheld connections, etc. The workstations typically include one or more applications designed to view maintenance alarms and alerts generated by field devices within the process plant, to test devices within the process plant, and to perform maintenance activities on the field devices and other devices within the process plant. Similar diagnostic applications have been developed to diagnose problems within the supporting equipment within the process plant.

Commercial software such as the AMS™ Suite: Intelligent Device Manager from Emerson Process Management enables communication with and stores data pertaining to field devices to ascertain and track the operating state of the field devices. See also U.S. Pat. No. 5,960,214, entitled “Integrated Communication Network for use in a Field Device Management System.” In some instances, the AMS™ Suite: Intelligent Device Manager software may be used to communicate with a field device to change parameters within the field device, to cause the field device to run applications on itself such as, for example, self-calibration routines or self-diagnostic routines, to obtain information about the status or health of the field device, etc. This information may include, for example, status information (e.g., whether an alarm or other similar event has occurred), device configuration information (e.g., the manner in which the field device is currently or may be configured and the type of measuring units used by the field device), device parameters (e.g., the field device range values and other parameters), etc. Of course, this information may be used by a maintenance person to monitor, maintain, and/or diagnose problems with field devices.

Similarly, many process plants include equipment monitoring and diagnostic applications such as, for example, the Machinery Health® application provided by CSI Systems, or any other known applications used to monitor, diagnose, and optimize the operating state of various rotating equipment. Maintenance personnel usually use these applications to maintain and oversee the performance of rotating equipment in the plant, to determine problems with the rotating equipment, and to determine when and if the rotating equipment must be repaired or replaced. Similarly, many process plants include power control and diagnostic applications such as those provided by, for example, the Liebert and ASCO companies, to control and maintain the power generation and distribution equipment. It is also known to run control optimization applications such as, for example, real-time optimizers (RTO+), within a process plant to optimize the control activities of the process plant. Such optimization applications typically use complex algorithms and/or models of the process plant to predict how inputs may be changed to optimize operation of the process plant with respect to some desired optimization variable such as, for example, profit.

These and other diagnostic and optimization applications are typically implemented on a system-wide basis in one or more of the operator or maintenance workstations, and may provide preconfigured displays to the operator or maintenance personnel regarding the operating state of the process plant, or the devices and equipment within the process plant. Typical displays include alarming displays that receive alarms generated by the process controllers or other devices within the process plant, control displays indicating the operating state of the process controllers and other devices within the process plant, maintenance displays indicating the operating state of the devices within the process plant, etc. Likewise, these and other diagnostic applications may enable an operator or a maintenance person to retune a control loop or to reset other control parameters, to run a test on one or more field devices to determine the current status of those field devices, or to calibrate field devices or other equipment.

While these various applications and tools may facilitate identification and correction of problems within a process plant, these diagnostic applications are generally configured to be used only after a problem has already occurred within a process plant and, therefore, after an abnormal situation already exists within the plant. Unfortunately, an abnormal situation may exist for some time before it is detected, identified, and corrected using these tools. Delayed abnormal situation processing may result in the suboptimal performance of the process plant for the period of time during which the problem is detected, identified and corrected. In many cases, a control operator first detects that a problem exists based on alarms, alerts or poor performance of the process plant. The operator will then notify the maintenance personnel of the potential problem. The maintenance personnel may or may not detect an actual problem and may need further prompting before actually running tests or other diagnostic applications, or performing other activities needed to identify the actual problem. Once the problem is identified, the maintenance personnel may need to order parts and schedule a maintenance procedure, all of which may result in a significant period of time between the occurrence of a problem and the correction of that problem. During this delay, the process plant may run in an abnormal situation generally associated with the sub-optimal operation of the plant.

Additionally, many process plants can experience an abnormal situation which results in significant costs or damage within the plant in a relatively short amount of time. For example, some abnormal situations can cause significant damage to equipment, the loss of raw materials, or significant unexpected downtime within the process plant if these abnormal situations exist for even a short amount of time. Thus, merely detecting a problem within the plant after the problem has occurred, no matter how quickly the problem is corrected, may still result in significant loss or damage within the process plant. As a result, it is desirable to try to prevent abnormal situations from arising in the first place, instead of simply trying to react to and correct problems within the process plant after an abnormal situation arises.

One technique, disclosed in U.S. patent application Ser. No. 09/972,078, now U.S. Pat. No. 7,085,610, entitled “Root Cause Diagnostics,” (based in part on U.S. patent application Ser. No. 08/623,569, now U.S. Pat. No. 6,017,143) may be used to predict an abnormal situation within a process plant before the abnormal situations actually arises. The entire disclosures of both of these applications are hereby incorporated by reference herein. Generally speaking, this technique places statistical data collection and processing blocks or statistical processing monitoring (SPM) blocks, in each of a number of devices, such as field devices, within a process plant. The statistical data collection and processing blocks collect process variable data and determine certain statistical measures associated with the collected data, such as the mean, median, standard deviation, etc. These statistical measures may then be sent to a user and analyzed to recognize patterns suggesting the future occurrence of a known abnormal situation. Once the system predicts an abnormal situation, steps may be taken to correct the underlying problem and avoid the abnormal situation.

Other techniques have been developed to monitor and detect problems in a process plant. One such technique is referred to as Statistical Process Control (SPC). SPC has been used to monitor variables associated with a process and flag an operator when the quality variable moves from its “statistical” norm. With SPC, a small sample of a variable, such as a key quality variable, is used to generate statistical data for the small sample. The statistical data for the small sample is then compared to statistical data corresponding to a much larger sample of the variable. The variable may be generated by a laboratory or analyzer, or retrieved from a data historian. SPC alarms are generated when the small sample's average or standard deviation deviates from the large sample's average or standard deviation, respectively, by some predetermined amount. An intent of SPC is to avoid making process adjustments based on normal statistical variation of the small samples. Charts of the average or standard deviation of the small samples may be displayed to the operator on a console separate from a control console.

Another technique analyzes multiple variables and is referred to as multivariable statistical process control (MSPC). This technique uses algorithms such as principal component analysis (PCA) and partial least squares (PLS), which analyze historical data to create a statistical model of the process. In particular, samples of variables corresponding to normal operation and samples of variables corresponding to abnormal operation are analyzed to generate a model to determine when an alarm should be generated. Once the model has been defined, variables corresponding to a current process may be provided to the model, which may generate an alarm if the variables indicate an abnormal operation.

A further technique includes detecting an abnormal operation of a process in a process plant with a configurable model of the process. The technique includes multiple regression models corresponding to several discrete operations of the process plant. Regression modeling in a process plant is disclosed in U.S. patent application Ser. No. 11/492,467 entitled “Method and System for Detecting Abnormal Operation in a Process Plant,” the entire disclosure of which is hereby incorporated by reference herein. The regression model determines if the observed process significantly deviates from a normal output of the model. If a significant deviation occurs, the technique alerts an operator or otherwise brings the process back into the normal operating range.

With model-based performance monitoring system techniques, a model is utilized, such as a correlation-based model, a first-principles model, or a regression model that relates process inputs to process outputs. For regression modeling, an association or function is determined between a dependent process variable and one or more independent variables. The model may be calibrated to the actual plant operation by adjusting internal tuning constants or bias terms. The model can be used to predict when the process is moving into an abnormal condition and alert the operator to take action. An alarm may be generated when there is a significant deviation in actual versus predicted behavior or when there is a notable change in a calculated efficiency parameter. Model-based performance monitoring systems typically cover as small as a single unit operation (e.g. a pump, a compressor, a fired or coker heater, a column, etc.) or a combination of operations that make up a process unit of a process plant (e.g. crude unit, fluid catalytic cracking unit (FCCU), coker unit of a refinery, reformer, etc.).

While the above techniques may be applied to a variety of process industries, refining is one industry in which abnormal situation prevention is particularly applicable. More particularly, abnormal situation prevention is particularly applicable to coker heaters as used in the refining industry. Generally, a coker heater processes coke or residuum feed in a refinery by heating the crude petroleum product and residuum feed in a number of passes through the coker heater. One particular abnormal condition associated with coker heaters is that of high coking conditions within the heated passes that impede the feed flow within the conduits, reduce heater efficiency, and reduce coker unit output.

### SUMMARY OF THE DISCLOSURE

A system and method to facilitate the monitoring and diagnosis of a process control system and any elements thereof is disclosed with a specific premise of abnormal situation prevention in a coker heater of a coker unit in a process plant. Monitoring and diagnosis of faults in a coker heater may include statistical analysis techniques, such as regression. In particular, on-line process data may be collected from an operating coker heater in a coker unit of a refinery. The process data may be representative of a normal operation of the process when it is on-line and operating normally. A statistical analysis may be used to develop a model of the process based on the collected data and the model may be stored along with the collected process data. Alternatively, or in conjunction, monitoring of the process may be performed which uses a model of the process developed using statistical analysis to generate an output based on a parameter of the model. The output may include a statistical output based on the results of the model, normalized process variables based on the training data, process variable limits or model components, and process variable ratings based on the training data and model components. Each of the outputs may be used to generate visualizations for process monitoring or process diagnostics and may perform alarm diagnostics to detect abnormal situations in the process.

### BRIEF DESCRIPTION OF THE DRAWINGS

FIG. 1 is an exemplary block diagram of a process plant having a distributed process control system and network including one or more operator and maintenance workstations, controllers, field devices and supporting equipment;

FIG. 2 is an exemplary block diagram of a portion of the process plant of FIG. 1, illustrating communication interconnections between various components of an abnormal situation prevention system located within different elements of the process plant including a coking unit;

FIG. 3a is one example of an area of a delayed coker area of a process plant;

FIG. 3b is one example of a coker heater within a coker area of a process plant;

FIG. 4 is a block diagram of an example abnormal operation detection (AOD) system;

FIG. 5 is one example of an abnormal situation prevention module to implement a method for abnormal situation prevention in a coker heater;

FIG. 6 is one example of logic that may be used to determine a status of a pass within a coker heater;

FIG. 7 is one example of a regression block for use in conjunction with a AOD system in a process plant;

FIG. 8 is one example of a flow diagram for abnormal situation prevention in a coker heater using the AOD system;

FIG. 9 is a flow diagram of an example of initially training the AOD system;

FIG. 10A is a graph showing a plurality of data sets that may be collected during a LEARNING state in an AOD system and used by the regression block of FIG. 7 to develop a regression model;

FIG. 10B is a graph showing an initial regression model developed using the plurality of data sets of FIG. 10A;

FIG. 11 is a flow diagram of an example method that may be implemented using the example AOD system of FIGS. 4-7;

FIG. 12A is a graph showing a received data set and a corresponding predicted value generated during a MONITORING state of an AOD system by the block of FIG. 7;

FIG. 12B is a graph showing another received data set and another corresponding predicted value generated by the block of FIG. 7;

FIG. 12C is a graph showing a received data set that is out of a validity range of the block of FIG. 7;

FIG. 13A is a graph showing a plurality of data sets in different operating region collected during a LEARNING state of an AOD system and that may be used by the model of FIG. 7 to develop a second regression model in a different operating region;

FIG. 13B is a graph showing a second regression model developed using the plurality of data sets of FIG. 13A;

FIG. 13C is a graph showing an updated model and its range of validity, and also showing a received data set and a corresponding predicted value generated during a MONITORING state of an AOD system;

FIG. 14 is a flow diagram of an example method for updating a model of an AOD system;

FIG. 15 is an example state transition diagram corresponding to an alternative operation of an AOD system such as the AOD systems of FIGS. 4-7;

FIG. 16 is a flow diagram of an example method of operation in a LEARNING state of an AOD system;

FIG. 17 is a flow diagram of an example method for updating a model of an AOD system;

FIG. 18 is a flow diagram of an example method of operation in a MONITORING state of an AOD system;

FIG. 19 is one example of an operator display for use with abnormal situation prevention in a coker heater;

FIG. 20 is another example of an operator display for use with abnormal situation prevention in a coker heater;

FIG. 21 is another example of an operator display for use with abnormal situation prevention in a coker heater;

FIG. 22 is another example of an operator display for use with abnormal situation prevention in a coker heater; and

FIG. 23 is an example of a coker abnormal situation prevention module implemented in a process control platform or system of a process plant.

### DETAILED DESCRIPTION

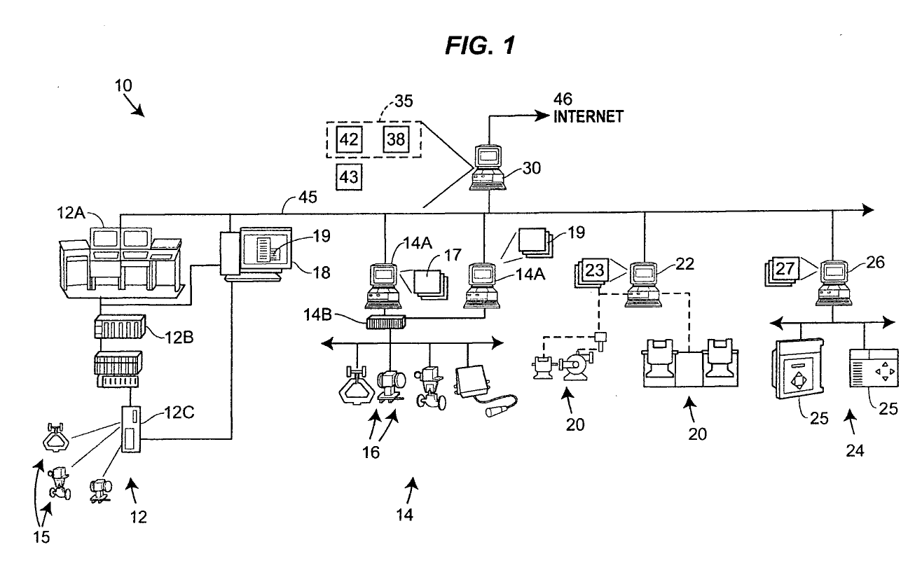

Referring now to FIG. 1, an exemplary process plant 10 in which an abnormal situation prevention system may be implemented includes a number of control and maintenance systems interconnected together with supporting equipment via one or more communication networks. The process control system 12 may be a traditional process control system such as a PROVOX or RS3 system or any other control system which includes an operator interface 12A coupled to a controller 12B and to input/output (I/O) cards 12C, that, in turn, are coupled to various field devices such as analog and Highway Addressable Remote Transmitter (HART) field devices 15. The process control system 14, which may be a distributed process control system, includes one or more operator interfaces 14A coupled to one or more distributed controllers 14B via a bus, such as an Ethernet bus. The controllers 14B may be, for example, DeltaV™ controllers sold by Emerson Process Management of Austin, Tex. or any other desired type of controllers. The controllers 14B are connected via I/O devices to one or more field devices 16, such as for example, HART or Fieldbus field devices or any other smart or non-smart field devices including, for example, those that use any of the PROFIBUS®, WORLDFIP®, Device-Net®, AS-Interface and CAN protocols. As is known, the field devices 16 may provide analog or digital information to the controllers 14B related to process variables as well as to other device information. The operator interfaces 14A may store and execute tools 17, 19 available to the process control operator for controlling the operation of the process including, for example, control optimizers, diagnostic experts, neural networks, tuners, etc.

Still further, maintenance systems, such as computers executing the AMS™ Suite: Intelligent Device Manager application described above and/or the monitoring, diagnostics and communication applications described below may be connected to the process control systems 12 and 14 or to the individual devices therein to perform maintenance, monitoring, and diagnostics activities. For example, a maintenance computer 18 may be connected to the controller 1 2B and/or to the devices 15 via any desired communication lines or networks (including wireless or handheld device networks) to communicate with and, in some instances, reconfigure or perform other maintenance activities on the devices 15. Similarly, maintenance applications such as the AMS™ Suite: Intelligent Device Manager application may be installed in and executed by one or more of the user interfaces 14A associated with the distributed process control system 14 to perform maintenance and monitoring functions, including data collection related to the operating status of the devices 16.

The process plant 10 also includes various rotating equipment 20, such as turbines, motors, etc. which are connected to a maintenance computer 22 via some permanent or temporary communication link (such as a bus, a wireless communication system or hand held devices which are connected to the equipment 20 to take readings and are then removed). The maintenance computer 22 may store and execute any number of monitoring and diagnostic applications 23, including commercially available applications, such as those provided by CSI (an Emerson Process Management Company), as well the applications, modules, and tools described below, to diagnose, monitor and optimize the operating state of the rotating equipment 20 and other equipment in the plant. Maintenance personnel usually use the applications 23 to maintain and oversee the performance of equipment 20 in the plant 10, to determine problems with the rotating equipment 20 and to determine when and if the equipment 20 must be repaired or replaced. In some cases, outside consultants or service organizations may temporarily acquire or measure data pertaining to the rotating equipment 20 and use this data to perform analyses for the rotating equipment 20 to detect problems, poor performance, or other issues effecting the rotating equipment 20. In these cases, the computers running the analyses may not be connected to the rest of the system 10 via any communication line or may be connected only temporarily.

Similarly, a power generation and distribution system 24 having power generating and distribution equipment 25 associated with the plant 10 is connected via, for example, a bus, to another computer 26 which runs and oversees the operation of the power generating and distribution equipment 25 within the plant 10. The computer 26 may execute known power control and diagnostics applications 27 such as those provided by, for example, Liebert and ASCO or other companies to control and maintain the power generation and distribution equipment 25. Again, in many cases, outside consultants or service organizations may use service applications that temporarily acquire or measure data pertaining to the equipment 25 and use this data to perform analyses for the equipment 25 to detect problems, poor performance, or other issues effecting the equipment 25. In these cases, the computers (such as the computer 26) running the analyses may not be connected to the rest of the system 10 via any communication line or may be connected only temporarily.

As illustrated in FIG. 1, a computer system 30 implements at least a portion of an abnormal situation prevention system 35, and in particular, the computer system 30 stores and implements a configuration application 38 and, optionally, an abnormal operation detection system 42, a number of embodiments of which will be described in more detail below. Additionally, the computer system 30 may implement an alert/alarm application 43.

Generally speaking, the abnormal situation prevention system 35 may communicate with abnormal operation detection systems (not shown in FIG. 1) optionally located in the field devices 15, 16, the controllers 12B, 14B, the rotating equipment 20 or its supporting computer 22, the power generation equipment 25 or its supporting computer 26, and any other desired devices and equipment within the process plant 10, and/or the abnormal operation detection system 42 in the computer system 30, to configure each of these abnormal operation detection systems and to receive information regarding the operation of the devices or subsystems that they are monitoring. The abnormal situation prevention system 35 may be communicatively connected via a hardwired bus 45 to each of at least some of the computers or devices within the plant 10 or, alternatively, may be connected via any other desired communication connection including, for example, wireless connections, dedicated connections which use OPC, intermittent connections, such as ones which rely on handheld devices to collect data, etc. Likewise, the abnormal situation prevention system 35 may obtain data pertaining to the field devices and equipment within the process plant 10 via a LAN or a public connection, such as the Internet, a telephone connection, etc. (illustrated in FIG. 1 as an Internet connection 46) with such data being collected by, for example, a third party service provider. Further, the abnormal situation prevention system 35 may be communicatively coupled to computers/devices in the plant 10 via a variety of techniques and/or protocols including, for example, Ethernet, Modbus, HTML, XML, proprietary techniques/protocols, etc. Thus, although particular examples using OPC to communicatively couple the abnormal situation prevention system 35 to computers/devices in the plant 10 are described herein, one of ordinary skill in the art will recognize that a variety of other methods of coupling the abnormal situation prevention system 35 to computers/devices in the plant 10 can be used as well.

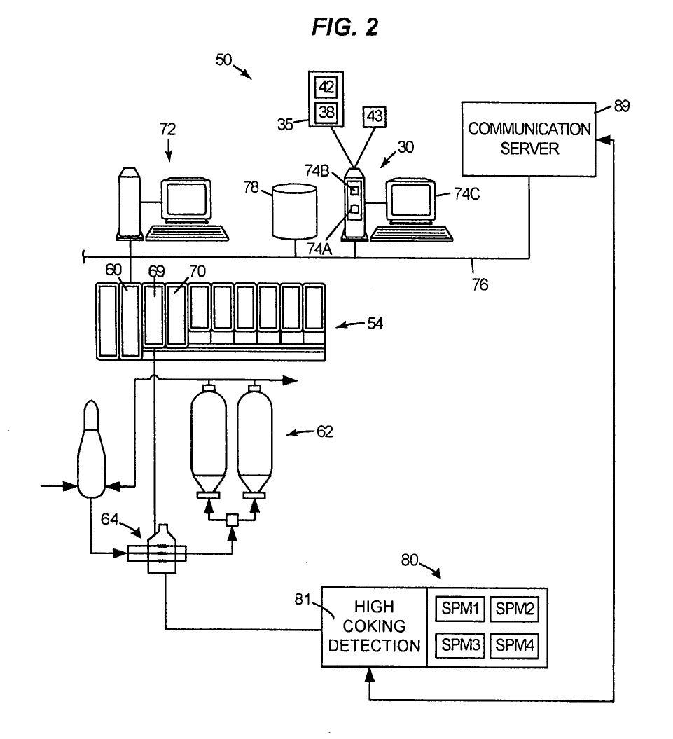

FIG. 2 illustrates a portion 50 of the example process plant 10 of FIG. 1 for the purpose of describing one manner in which the abnormal situation prevention system 35 and/or the alert/alarm application 43 may communicate with a coking unit 62 in the portion 50 of the example process plant 10. In one example, the process plant 10 or portion 50 of the process plant may be a refinery plant for processing petroleum coke by heating crude petroleum product and residuum feed in a number of passes through a coker heater 64. While FIG. 2 illustrates communications between the abnormal situation prevention system 35 and one or more abnormal operation detection systems within the coker heater 64, it will be understood that similar communications can occur between the abnormal situation prevention system 35 and other devices and equipment within the process plant 10, including any of the devices and equipment illustrated in FIG. 1.

The portion 50 of the process plant 10 illustrated in FIG. 2 includes a distributed process control system 54 having one or more process controllers 60 connected to one or more coker heaters 64 of a coking unit 62 via input/output (I/O) cards or devices 69 and 70, which may be any desired types of I/O devices conforming to any desired communication or controller protocol. Additionally, the coking unit 62 and/or the coker heater 64 may conform to any desired open, proprietary or other communication or programming protocol, it being understood that the I/O devices 69 and 70 must be compatible with the desired protocol used by the coking unit 62 and coker heater 64. Although not shown in detail, the coking unit 62 and coker heater 64 may include any number of additional devices, including, but not limited to, field devices, HART devices, sensors, valves, transmitters, positioners, etc.

In any event, one or more user interfaces or computers 72 and 30 (which may be any type of personal computer, workstation, etc.) accessible by plant personnel such as configuration engineers, process control operators, maintenance personnel, plant managers, supervisors, etc. are coupled to the process controllers 60 via a communication line or bus 76 which may be implemented using any desired hardwired or wireless communication structure, and using any desired or suitable communication protocol such as, for example, an Ethernet protocol. In addition, a database 78 may be connected to the communication bus 76 to operate as a data historian that collects and stores configuration information as well as on-line process variable data, parameter data, status data, and other data associated with the process controllers 60 and the coking unit 62 and other field devices within the process plant 10. Thus, the database 78 may operate as a configuration database to store the current configuration, including process configuration modules, as well as control configuration information for the process control system 54 as downloaded to and stored within the process controllers 60 and the devices of the coking unit 62 and other field devices within the process plant 10. Likewise, the database 78 may store historical abnormal situation prevention data, including statistical data collected by the coking unit 62 (or, more particularly, devices of the coking unit 62) and other field devices within the process plant 10, statistical data determined from process variables collected by the coking unit 62 (or, more particularly, devices of the coking unit 62) and other field devices, and other types of data that will be described below.

While the process controllers 60, I/O devices 69 and 70, coking unit 62, and the coker heater 64 are typically located down within and distributed throughout the sometimes harsh plant environment, the workstations 72 and 74, and the database 78 are usually located in control rooms, maintenance rooms or other less harsh environments easily accessible by operators, maintenance personnel, etc. Although only one coking unit 62 is shown with only one coker heater 64, it should be understood that a process plant 10 may have multiple coking units 62 some of which may have multiple coker heaters 64. The abnormal situation prevention techniques described herein may be equally applied to any of a number of coker heaters 64 or coking units 62.

Generally speaking, the process controllers 60 may store and execute one or more controller applications that implement control strategies using a number of different, independently executed, control modules or blocks. The control modules may each be made up of what are commonly referred to as function blocks, wherein each function block is a part or a subroutine of an overall control routine and operates in conjunction with other function blocks (via communications called links) to implement process control loops within the process plant 10. As is well known, function blocks, which may be objects in an object-oriented programming protocol, typically perform one of an input function, a control function, or an output function. For example, an input function may be associated with a transmitter, a sensor or other process parameter measurement device. A control function may be associated with a control routine that performs PID, fuzzy logic, or another type of control. Also, an output function may control the operation of some device, such as a valve, to perform some physical function within the process plant 10. Of course, hybrid and other types of complex function blocks exist, such as model predictive controllers (MPCs), optimizers, etc. It is to be understood that while the Fieldbus protocol and the DeltaV™ system protocol use control modules and function blocks designed and implemented in an object-oriented programming protocol, the control modules may be designed using any desired control programming scheme including, for example, sequential function blocks, ladder logic, etc., and are not limited to being designed using function blocks or any other particular programming technique.

As illustrated in FIG. 2, the maintenance workstation 74 includes a processor 74A, a memory 74B and a display device 74C. The memory 74B stores the abnormal situation prevention application 35 and the alert/alarm application 43 discussed with respect to FIG. 1 in a manner that these applications can be implemented on the processor 74A to provide information to a user via the display 74C (or any other display device, such as a printer).

The coker heater 64 and/or the coking unit 62, and/or the devices of the coker heater 64 and coking unit 62 in particular, may include a memory (not shown) for storing routines such as routines for implementing statistical data collection pertaining to one or more process variables sensed by sensing devices and/or routines for abnormal operation detection, which will be described below. Each of one or more of the coker heaters 64 and the coking unit 62, and/or some or all of the devices thereof in particular, may also include a processor (not shown) that executes routines such as routines for implementing statistical data collection and/or routines for abnormal operation detection. Statistical data collection and/or abnormal operation detection need not be implemented by software. Rather, one of ordinary skill in the art will recognize that such systems may be implemented by any combination of software, firmware, and/or hardware within one or more field devices and/or other devices.

As shown in FIG. 2, the coker heater 64 (and potentially some or all heaters in a coking unit 62) include one or more abnormal operation detection blocks 80, that will be described in more detail below. While the block 80 of FIG. 2 is illustrated as being located in the coker heater 64, this or a similar block could be located in any number of coker heaters 62 or within various other equipment and devices in the coking unit 62, in other devices, such as the controller 60, the I/O devices 68, 70 or any of the devices illustrated in FIG. 1. Additionally, if the coking unit 62 includes more than one coker heater 64, the block 80 could be in any subset of the coker heaters 64, such as in one or more devices of the coker heaters 64, for example (e.g., temperature sensor, temperature transmitter, etc.).

Generally speaking, the block 80 or sub-elements of the block 80, collect data, such a process variable data, from the device in which they are located and/or from other devices. For example, the block 80 may collect the temperature difference variable from devices within the coker heater 64, such as a temperature sensor, a temperature transmitter, or other devices, or may determine the temperature difference variable from temperature measurements from the devices. The block 80 may be included with the coking unit 62 or the coker heater 64 and may collect data through valves, sensors, transmitters, or any other field device. Additionally, the block 80 or sub-elements of the block may process the variable data and perform an analysis on the data for any number of reasons. For example, the block 80 that is illustrated as being associated with the coker heater 64, may have a high coking detection routine 81 that analyzes gain (a measure of flow rate through the coker heater 64 over a flow valve position) and heat transfer (the change in temperature of the flow as it passes through the coker heater 64) process variable data. Generally, a decrease in either or both of the gain and heat transfer process variables may indicate a high coking condition.

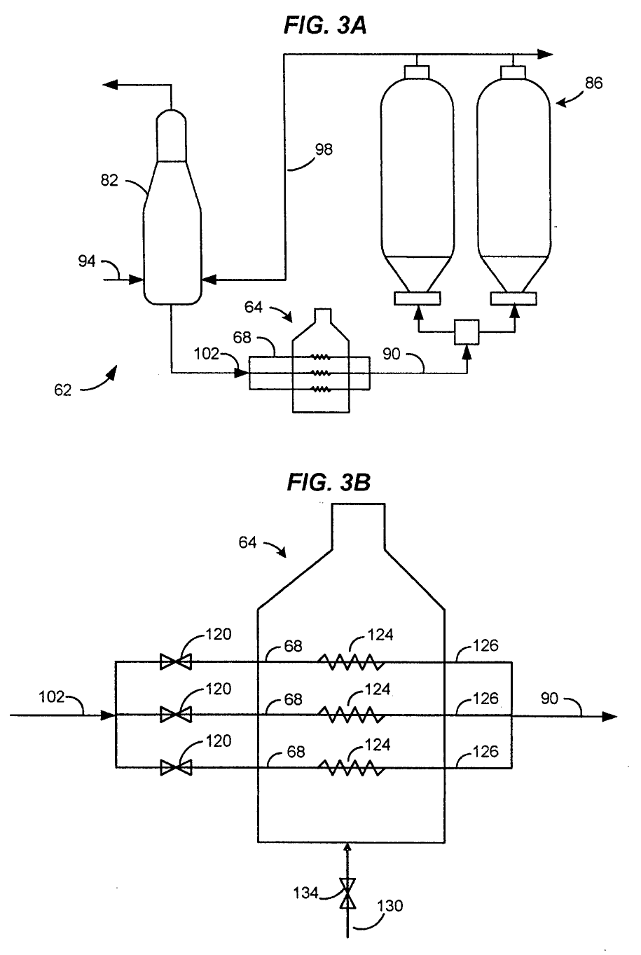

FIGS. 3A and 3B illustrate a more detailed view of the coking unit 62 and the coker heater 64. By way of background, the process plant 10 may include the coking unit 62 to process the heaviest component (coke) from another portion of the plant 10 prior to sending the coke to a storage area of the plant. Generally, delayed coking is a thermal cracking process used in refineries to upgrade and convert residuum from the distillation of crude oil into liquid and gas product streams. Delayed coking produces a solid, concentrated carbon metal called petroleum coke. Briefly, a coker heater 64 with a number of horizontal conduits 68 heats the residuum from a fractionation column 82 to thermal cracking temperatures. With short residence time in the conduits 68, coking of the feed material is thereby “delayed” until it reaches the downstream coking drums 86. The delayed coker 62 process may be described as batch-continuous in that the flow through the coker heater 64 is uninterrupted. From the coker heater, 64, the downstream feed 90 is switched between two coking drums 86. One drum may be on-line, filling with heated coke, while the other drum is being steam-stripped, cooled, decoked, pressure checked, and warmed up. The overhead vapors from the coke drums flow to the fractionation column 82 including a reservoir in the bottom where the fresh feed 94 (i.e., crude oil and residuum) is combined with condensed product vapors (recycle) 98 to make up the coker heater upstream feed 102.

With reference to FIG. 3B, in one embodiment, the delayed coker unit processes the coke by heating the crude petroleum product and residuum feed 102 in a number of passes through the coker heater 64. The feed 102 is first divided into a number of passes, and passed through flow control valves 120 before entering the heater 64. While FIG. 3B illustrates three passes, the plant 10 may initiate any number of passes through the heater 64. Each pass may include a conduit 68, a heating element 124, and an outlet 126. The heating elements 124 are supplied through a fuel feed 130 and may be controlled by a fuel control valves 134 or other regulating means. Additionally, a load-balancing control (not shown) may regulate the flow through each of the conduits 68. Process variables (such as flow rate 162, valve position 166, feed temperature at the beginning of a pass 170, and feed temperature at the end of a pass 174) associated with the coker heater 64 may provide information for abnormal situation prevention in the coker unit 62. The heater 64 may include a number of features to ensure proper residuum heating during the delayed coking process. For example, the heater 64 may include: 1) high in-conduit velocities for maximum inside heat transfer coefficient; 2) minimum residence time in the furnace, especially above the cracking temperature threshold; 3) a constantly rising temperature gradient; 4) optimum flux rate with minimum practicable maldistribution based on peripheral tube surface; 5) symmetrical piping and coil arrangement within the furnace enclosure; and 6) multiple steam injection points for each heater pass to increase feed velocity in the conduits 68 and reduce partial pressure in the coke drums 86 so that more gas oil product is carried out. If these principles are not followed, excessive coke may build up inside the one or more conduits 68 during operation of the coker heater 64 and may lead to an abnormal situation. Coke build up inside the conduits 68 may degrade the heating element 124 efficiency and the other passes may be compensated with more load. Continuing build up in the coker heater 64 may effect the entire unit or the refining process plant 10, generally.

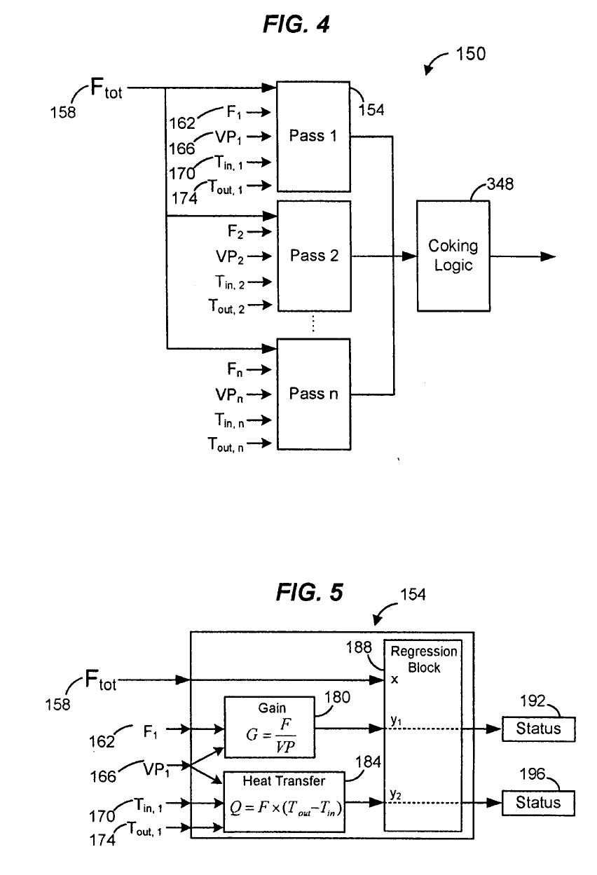

With reference to FIGS. 2-4, an abnormal operation detection block 80 may monitor each conduit 68 in the coker heater 64 to check for high coking. Generally, a decrease in either the gain or heat transfer rate or a decrease in both of the gain and/or heat transfer rate within a conduit 68 during a pass 154 as the total feed rate (Fₜₒₜ) 158 changes may indicate a high coking condition in the conduit 68 and may also signal an upstream or downstream abnormal situation. As used herein, a conduit 68 (FIG. 3B) may describe the physical structure within the coker heater 64 through which crude oil, residuum, and other matter flows to be heated. Further, as user herein, a pass 154 (FIG. 4) may indicate the flow of the crude oil, residuum, and other matter itself through a particular conduit 68 during the operation of the coker heater 64 within the coker unit 62. In one embodiment, gain may be represented as

$$G = \frac{F}{VP} ,$$

where F=the flow rate through the conduit 68, and VP=the flow control valve 120 position. In a further embodiment, the valve position (VP) may be substituted with a controller output (CO) or controller demand (CD). Heat transfer may be represented as Q=F×cₚ×ΔT, where F=the flow rate through the conduit 68, cₚ=the specific heat, and ΔT=the temperature difference across the pass 154. Q may also be a change in the heat transfer from some initial state, rendering the value of cₚ=to a constant. Also, because the coker heater 64 may be continuously heating the feed 102, the outlet temperature may always be higher than the inlet temperature and ΔT may equal Tₒᵤₜ−Tᵢₙ. The heat transfer value may then be reduced to: Q=F×(Tₒᵤₜ−Tᵢₙ), where F=the flow rate through the conduit 68, Tₒᵤₜ is the temperature of the residuum at the outlet 126, and Tᵢₙ is the temperature of the residuum at the flow control valve 120 or at any other point of the conduit 68 before the residuum reaches the heating element 124. The total feed rate (Fₜₒₜ) may be a measurement of the amount of residuum or other substances entering the conduits 68 through the feed 102. Because the gain and heat transfer rate changes as the total feed rate (Fₜₒₜ) changes, the coker abnormal situation prevention module 150 (FIG. 4) may have access to the initial gain or heat transfer rates for all total feed rates at which the coking unit 62 normally operates, i.e., (Fₘᵢₙ to Fₘₐₓ).

The block 80 may include a set of one or more statistical process monitoring (SPM) blocks or units such as blocks SPM1-SPM4 which may collect process variable or other data within the coker heater 64 and perform one or more statistical calculations on the collected data to determine, for example, a mean, a median, a standard deviation, a root-mean-square (RMS), a rate of change, a range, a minimum, a maximum, etc. of the collected data and/or to detect events such as drift, bias, noise, spikes, etc., in the collected data. The specific statistical data generated, and the method in which it is generated is not critical. Thus, different types of statistical data can be generated in addition to, or instead of, the specific types described above. Additionally, a variety of techniques, including known techniques, can be used to generate such data. The term statistical process monitoring (SPM) block is used herein to describe functionality that performs statistical process monitoring on at least one process variable or other process parameter, such as the gain and/or heat transfer value, and may be performed by any desired software, firmware or hardware within the device or even outside of a device for which data is collected. It will be understood that, because the SPMs are generally located in the devices where the device data is collected, the SPMs can acquire quantitatively more and qualitatively more accurate process variable data. As a result, the SPM blocks are generally capable of determining better statistical calculations with respect to the collected process variable data than a block located outside of the device in which the process variable data is collected.

It is to be understood that although the block 80 is shown to include SPM blocks in FIG. 2, the SPM blocks may instead be stand-alone blocks separate from the blocks 80 and 82, and may be located in the same coker heater as another abnormal operation detection block or may be in a different device. The SPM block discussed herein may comprise known FOUNDATION™ Fieldbus SPM blocks, or SPM blocks that have different or additional capabilities as compared with known FOUNDATION™ Fieldbus SPM blocks. The term statistical process monitoring (SPM) block is used herein to refer to any type of block or element that collects data, such as process variable data, and performs some statistical processing on this data to determine a statistical measure, such as a mean, a standard deviation, etc. As a result, this term is intended to cover software, firmware, hardware and/or other elements that perform this function, whether these elements are in the form of function blocks, or other types of blocks, programs, routines or elements and whether or not these elements conform to the FOUNDATION™ Fieldbus protocol, or some other protocol, such as Profibus, HART, CAN, etc. protocols. If desired, the underlying operation of blocks 80, 82 may be performed or implemented at least partially as described in U.S. Pat. No. 6,017,143, which is hereby incorporated by reference herein.

It is to be further understood that although the block 80 is shown to include SPM blocks in FIG. 2, SPM blocks are not required. For example, abnormal operation detection routines of the block 80 could operate using process variable data not processed by an SPM block. As another example, the block 80 could receive and operate on data provided by one or more SPM blocks located in other devices. As yet another example, the process variable data could be processed in a manner that is not provided by many typical SPM blocks. As just one example, the process variable data could be filtered by a finite impulse response (FIR) or infinite impulse response (IIR) filter such as a bandpass filter or some other type of filter. As another example, the process variable data could be trimmed so that it remained in a particular range. Of course, known SPM blocks could be modified to provide such different or additional processing capabilities. While the block 80 includes four SPM blocks, the block 80 could have any other number of SPM blocks therein for collecting and determining statistical data.

Overview of an Abnormal Operation Detection (AOD) System in a Coker Heater

FIG. 4 is a block diagram of an example abnormal operation detection (AOD) system 150 that could be utilized in the abnormal operation detection block 80 or as the abnormal operation detection system 42 of FIG. 2 for a coker heater 64 abnormal situation prevention module. The AOD system 150 may be used to detect abnormal operations, also referred to throughout this application as abnormal situations or abnormal conditions, that have occurred or are occurring in the coking unit 62 or coker heater 64, such as high coking conditions indicated by decreasing gain or heat transfer. In addition, the AOD system 150 may be used to predict the occurrence of abnormal operations within the coking unit 62 or coker heater 64 before these abnormal operations actually arise, with the purpose of taking steps to prevent the predicted abnormal operation before any significant loss within coking unit 62, the coker heater 64, or the process plant 10 takes place, for example, by operating in conjunction with the abnormal situation prevention system 35.

In one example, each coker heater 64 may have a corresponding AOD system 150, though it should be understood that a common AOD system may be used for multiple heaters or for the coking unit 62 as a whole. As noted above, there are generally a number of passes 154, n, where a decrease in either or both of gain and heat transfer could indicate a high coking condition. However, because it is also possible that gain and heat transfer could change during normal operating conditions as a function of some load variable 158, the AOD system 150 learns the normal or baseline gain and heat transfer values for a range of values for the load variable 158.

As shown in FIG. 5, the load variable 158 and each monitored variable (flow rate 162, valve position 166, feed temperature at the beginning of a pass 170, and feed temperature at the end of a pass 174) are fed into a respective gain 180 and heat transfer 184 block. After calculating the gain 180 and heat transfer 184, the values are fed into a regression block 188. During the learning phase, which is described in more detail below, the regression block 188 creates a regression model to predict data generated from the corresponding gain or heat transfer as a function of data generated from the load variable 154. The data generated from gain or heat transfer and data generated from the load variable may include gain, heat transfer, and load variable data; gain, heat transfer, and load variable data that has been filtered or otherwise processed; statistical data generated from gain, heat transfer, and load variable data; etc. During the monitoring phase, which is also described in more detail below, the regression model predicts a value for data generated from either or both of gain 180 and heat transfer 184 given a value of data generated from the load variable 158 during operation of the coker heater 64. The regression block 188 outputs a status 192, 196 based upon a deviation, if any, between the predicted value of data generated from gain 180 and/or heat transfer 184 and a monitored value of data generated from gain 180 and/or heat transfer 184 for a given value of data generated from the load variable 158. For example, if the monitored value of either or both of gain 180 or heat transfer 184 significantly deviates from their predicted values, the regression block 188 may output a status of “Down”, which is an indication that high coking conditions are present in an associated pass 154. Otherwise, the regression block 188 may output the status as “Normal” for the given pass 154.

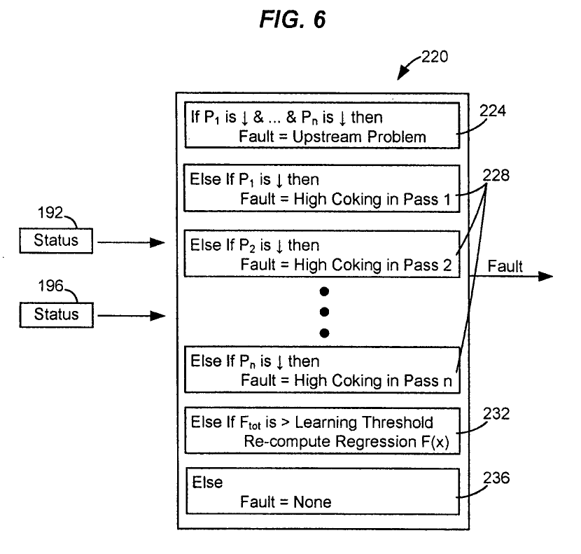

As shown in FIG. 6, a status decision block 220 receives the status 192, 196 from the regression block 188 and determines the status of the coker heater 64. The status decision block 220 may comprise a number of conditions or steps that, with the status 192, 196 of each pass 154, indicates an overall abnormal condition. For example, a first condition 224 may be that if, after processing at least one of the gain 180 and heat transfer 184 data, all the passes 154 are down, then the overall fault may be an upstream problem. An upstream problem may be an indication of an abnormal condition in any one of the plant 10 devices that function using at least a portion of the coker heater 64 output. A second condition 228 may be if any one pass 154 is down, then that may indicate a fault of high coking in that particular pass 154. The fault may indicate whether the high coking in each pass 154 was detected based upon gain 180 or heat transfer 184. A third condition 232 may be if the values of a load variable are outside the limits of the same variable as observed during the learning phase, then the output may be out of range and indicate that the regression block 188 may need to be re-computed as generally described below. A fourth condition 236 may be that any other observed condition is something other than the first 224, second 228, or third 232 conditions, then no fault is detected. Of course, many other conditions may be satisfied or evaluated within the a status decision block 220 to determine a status of the coker heater 64. The status decision block 220 may receive the status from other regression blocks 180, such as regression blocks 180 for other coker heaters 64, and determine the status of the coking unit 62. The monitored values 162, 166, 170, 174 may be derived by a variety of methods, including sensor measurements, modeled measurements based on other monitored process measurements, statistical measurements, analysis results, etc. As discussed further below, the values 162, 166, 170, 174 may be either the raw monitored values, an output of an SPM block, or other generated values.

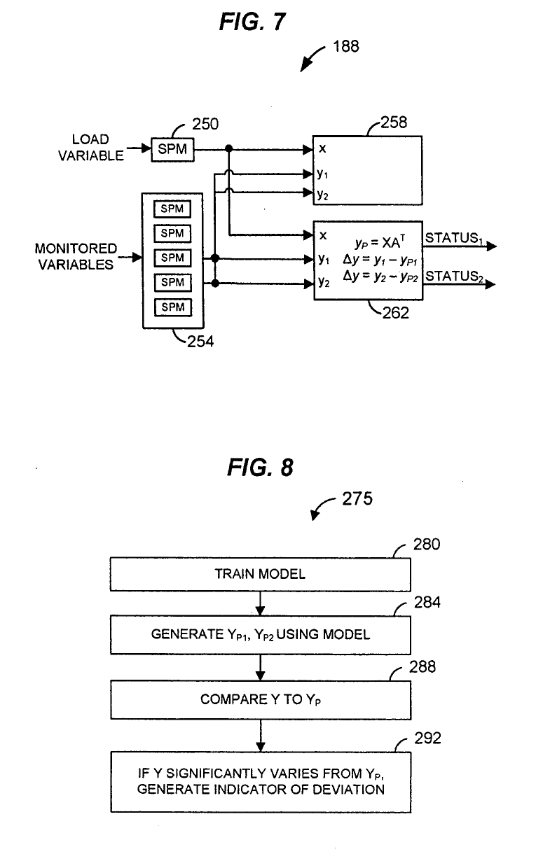

FIG. 7 is a block diagram of an example of a regression block 188 shown in FIG. 5. The regression block 188 includes a first SPM block 250 for a load variable, total feed rate (Fₜₒₜ), and a plurality of second SPM blocks 254 for each of the process variables to determine the monitored variables: flow rate 162, valve position 166, temperature of the flow at the beginning of a pass 170, and temperature of the feed at the end of the pass 174, to determine gain 180 and heat transfer 184. The first SPM block 250 receives the load variable and generates first statistical data from the load variable. The first statistical data could be any of various kinds of statistical data such as mean data, median data, standard deviation data, rate of change data, range data, etc., calculated from the load variable. Such data could be calculated based on a sliding window of the load variable data or based on non-overlapping windows of the load variable data. As one example, the first SPM block 250 may generate mean and standard deviation data over a user-specified sample window size, such as a most recent load variable sample and preceding samples of the load variables or any number of samples or amount of data that may be statistically useful. In this example, a mean load variable value and a standard deviation load variable value may be generated for each new load variable sample received by the first SPM block 250. As another example, the first SPM block 250 may generate mean and standard deviation data using non-overlapping time periods. In this example, a window of five minutes (or some other suitable time period) could be used, and a mean and/or standard deviation load variable value would thus be generated every five minutes. In a similar manner, the second SPM blocks 254 receive the monitored variables 162, 166, 170, 174 to measure gain and heat transfer of the coker heater 64 and generate second statistical data in a manner similar to the SPM block 250, such as mean and standard deviation data over a specified sample window.

The model 258 includes a load variable input, which is an independent variable input (x), from the SPM 250 and a monitored variable input, that is at least one dependent variable input (y₁, y₂), from the SPM 254. As discussed above, the monitored variables 162, 166, 170, 174 are used to calculate either or both of gain 180 or heat transfer 184 in the coker heater 64. As will be described in more detail below, the model 258 may be trained using a plurality of data sets (x, y₁, y₂), to model the monitored 162, 166, 170, 174 variables as a function of the load variable 154. The model 258 may use the mean, standard deviation or other statistical measure of the load variable 154 (X) and the monitored variables 162, 166, 170, 174 (Y) from the SPM's 250, 254 as the independent and dependent variable inputs (x, y) for regression modeling. For example, the means of the load variable and the monitored variables may be used as the (x, y₁, y₂) point in the regression modeling, and the standard deviation may be modeled as a function of the load variable and used to determine the threshold at which an abnormal situation is detected during the monitoring phase. As such, it should be understood that while the AOD system 150 is described as modeling the gain and/or heat transfer variables as a function of the load variable, the AOD system 150 may model various data generated from the gain and/or heat transfer variables as a function of various data generated from the load variable based on the independent and dependent inputs provided to the regression model, including, but not limited to, gain and/or heat transfer variables and load variable data, statistical data generated from the gain and/or heat transfer variable and load variable data, and gain and/or heat transfer variable and load variable data that has been filtered or otherwise processed. Further, while the AOD system 150 is described as predicting values of the gain and/or heat transfer variables and comparing the predicted values to the monitored values, the predicted and monitored values may include various predicted and monitored values generated from the gain and/or heat transfer variables, such as predicted and monitored gain and/or heat transfer variable data, predicted and monitored statistical data generated from the gain and/or heat transfer variable data, and predicted and monitored gain and/or heat transfer variable data that has been filtered or otherwise processed.

As will also be described in more detail below, the model 258 may include one or more regression models, with each regression model provided for a different operating region. Each regression model may utilize a function to model the dependent gain and heat transfer values as a function of the independent load variable over some range of the load variable. The regression model may comprise a linear regression model, for example, or some other regression model. Generally, a linear regression model comprises some linear combination of functions f(X), g(X), h(X), . . . . For modeling an industrial process, a typically adequate linear regression model may comprise a first order function of X (e.g., Y=m*X+b) or a second order function of X (e.g., Y=a*X²+b*X+c), however, other functions may also be suitable.

In the example shown in FIG. 7, the (x, y₁, y₂) points are stored during the learning phase. At the end of the learning phase, the regression coefficients are calculated to develop a regression model to predict the gain and heat transfer values as a function of the load variable. The maximum and minimum values of the load variable used to develop the regression model are also stored. The model 258 may be calculated as a function of observed load variable values (x) and corresponding observed gain or heat transfer values (y). In one example, the regression fits a polynomial of order p, such that predicted values (y_{P1}, y_{P2}) for the gain and/or heat transfer Y may be calculated based on the load variable values (x) (e.g., y_{Px}=a₀+a₁+ . . . +aₚx^{p}). Generally, the order of the polynomial p would be a user input, though other algorithms may be provided that automate the determination of the order of the polynomial. Of course, other types of functions may be utilized as well such as higher order polynomials, sinusoidal functions, logarithmic functions, exponential functions, power functions, etc.

After the AOD system 150 has been trained, the model 258 may be utilized by the deviation detector 262 to generate at lease one predicted value (y_{P1}, y_{P2}) of the dependent gain and/or heat transfer values Y based on a given independent load variable input (x) during a monitoring phase. The deviation detector 262 further utilizes gain and/or heat transfer input (y₁, y₂) and the independent load variable input (x) to the model 258. Generally speaking, the deviation detector 262 calculates the predicted values (y_{P1}, y_{P2}) for a particular load variable value and uses the predicted value as the “normal” or “baseline” gain and/or heat transfer. The deviation detector 262 compares the monitored gain and/or heat transfer value (y₁, y₂) to the predicted gain/heat transfer value (y_{P1}, y_{P2}), respectively, that is to determine if either or both of the gain and heat transfer value (y₁, y₂) is significantly deviating from the predicted value(s) (y_{P1}, y_{P2}) (e.g., Δy=y−y_{P}). If the monitored gain and/or heat transfer value (y₁, y₂) is significantly deviating from the predicted value (y_{P1}, y_{P2}), this may indicate that an abnormal situation has occurred, is occurring, or may occur in the near future, and thus the deviation detector 262 may generate an indicator of the deviation. For example, if the monitored gain value (y₁) is lower than the predicted gain value (y_{P1}) and the difference exceeds a threshold, an indication of an abnormal situation (e.g., “Down”) may be generated. If not, the status is “Normal”. In some implementations, the indicator of an abnormal situation may comprise an alert or alarm.

By illustration, f may be the regression block 188 that relates the total feed rate 158 to either or both of gain 180 and/or heat transfer 184, Fₜₒₜ may be the current value of the total feed rate 158, and may be the current value of either or both of gain 180 and/or heat transfer 184. The regression block 188 may calculate a normal value for any combination of gain 180 and heat transfer 184 at the observed total feed rate 158, for example, M₀=f(Fₜₒₜ) . Further, the regression block 188 may calculate a percentage change between the calculated normal value and the current value(s) for gain 180 and/or heat transfer 184, for example,

$$Δ M = M - {M}_{0} / {M}_{0} \times 100.$$

When ΔM<0 and −ΔM>Threshold, (i.e., the “normal” or “baseline” gain 180 and/or heat transfer 184) then the status 192, 196 may be “down” or otherwise may indicate the potential for high coking during the pass 154. If ΔM is any other value, the status 192, 196 may be normal. In another embodiment, the regression block 188 may compare either or both of gain 180 and/or heat transfer 184 to a statistical range of the predicted values for these variables. For example, if the measured variables are outside of a number of standard deviations (σ) of the predicted values for the same variables at the observed feed rate, then the block 188 may indicate a status 192, 196. The statistical comparison may be if M<M₀−3σ, then the status 192, 196 may be “down,” otherwise the status 192, 196 may be “normal.” When SPM is used with a regression analysis as disclosed in U.S. patent application Ser. No. 11/492,467, the standard deviation may be predicted based on Fₜₒₜ and the regression model developed during the learning phase. When the regression model is used with raw data from the SPM, the standard deviation may be based on the residuals of the data used during the learning phase. Of course, many other calculations involving the observed and predicted values of the variables 158, 162, 166, 170, 174 may be useful in detecting an abnormal condition.

In addition to monitoring the coker heater 64 for abnormal situations, the deviation detector 262 may also check to see if the load variable is within the limits seen during the development and training of the model. For example, during the monitoring phase the deviation detector 262 monitors whether a given value for the load variable is within the operating range of the regression model as determined by the minimum and maximum values of the load variable used during the learning phase of the model. If the load variable value is outside of the limits, the deviation detector 262 may output a status of “Out of Range” or other indication that the load variable is outside of the operating region for the regression model. The regression block 188 may either await an input from a user to develop and train a new regression model for the new operating region or automatically develop and train a new regression model for the new operating region, examples of which are provided further below.

One of ordinary skill in the art will recognize that the AOD system 150 and the regression block 188 can be modified in various ways. For example, the SPM blocks 250, 254 could be omitted, and the raw values of the load variable and the monitored variables of flow rate 162, valve position 166, temperature of the feed at the beginning of the pass 170, and temperature of the feed at the end of the pass 174 may be provided directly to the model 258 as the (x, y₁, y₂, . . . , yₙ) points used for regression modeling and provided directly to the deviation detector 262 for monitoring. As another example, other types of processing in addition to or instead of the SPM blocks 250 and 254 could be utilized. For example, the process variable data could be filtered, trimmed, etc., prior to the SPM blocks 250, 254 or in place of utilizing the SPM blocks 250, 254.

Additionally, although the model 258 is illustrated as having a single independent load variable input (x), multiple dependent variable inputs (y₁, y₂), and multiple predicted values (y_{P1}, y_{P2}), the model 258 could include a regression model that models one or more monitored variables as a function of multiple load variables. For example, the model 258 could comprise a multiple linear regression (MLR) model, a principal component regression (PCR) model, a partial least squares (PLS) model, a ridge regression (RR) model, a variable subset selection (VSS) model, a support vector machine (SVM) model, etc.

The AOD system 150 could be implemented wholly or partially in a coker heater 64 or a device of the coking unit 62 or the coker heater 64. As just one example, the SPM blocks 250, 254 could be implemented in a temperature sensor or temperature transmitter of the coker heater 64 and the model 258 and/or the deviation detector 262 could be implemented in the controller 60 (FIG. 2) or some other device. In one particular implementation, the AOD system 150 could be implemented as a function block, such as a function block to be used in system that implements a Fieldbus protocol. Such a function block may or may not include the SPM blocks 250, 254. In another implementation, each of at least some of the blocks 188, 250, 254, 258, and 262 may be implemented as a function block. For example, the blocks 250, 254, 258, and 262 may be implemented as function blocks of a regression block 188. However, the functions of each block may be distributed in a variety of manners. For example, the regression model 258 may provide the output (y_{P1}, y_{P2}) to the deviation detector 262, rather than the deviation detector 262 executing the regression model 258 to provide the prediction of the gain and heat transfer values (y_{P1}, y_{P2}). In this implementation, after it has been trained, the model 258 may be used to generate a predicted value (y_{P1}, Y_{P2}) of the gain or heat transfer monitored value (y_{P1}, y_{P2}) based on a given independent load variable input (x). The output (y_{P1}, y_{P2}) of the model 258 is provided to the deviation detector 262. The deviation detector 262 receives the output (y_{P1}, y_{P2}) of the regression model 258 as well as the dependent variable input (x) to the model 258. As above, the deviation detector 262 compares the monitored values (y₁, y₂) to the value (y_{P1}, y_{P2}) generated by the model 258 to determine if the dependent gain and/or heat transfer values (y₁, y₂) are significantly deviating from the predicted values (y_{P1}, y_{P2}).

The AOD system 150 may be in communication with the abnormal situation prevention system 35 (FIGS. 1 and 2A). For example, the AOD system 150 may be in communication with the configuration application 38 to permit a user to configure the AOD system 150. For instance, one or more of the SPM blocks 250 and 254, the model 258, and the deviation detector 262 may have user configurable parameters that may be modified via the configuration application 38.

Additionally, the AOD system 150 may provide information to the abnormal situation prevention system 35 and/or other systems in the process plant. For example, the deviation indicator generated by the deviation detector 262 or by the status decision block 220 could be provided to the abnormal situation prevention system 35 and/or the alert/alarm application 43 to notify an operator of the abnormal condition. As another example, after the model 258 has been trained, parameters of the model could be provided to the abnormal situation prevention system 35 and/or other systems in the process plant so that an operator can examine the model and/or so that the model parameters can be stored in a database. As yet another example, the AOD system 150 may provide (x), (y), and/or (y_{P}) values to the abnormal situation prevention system 35 so that an operator can view the values, for instance, when a deviation has been detected.

FIG. 8 is a flow diagram of an example method 275 for detecting an abnormal operation in the coking unit 62 or, more particularly, in a coker heater 64 of a coking unit 62. The method 275 could be implemented using the example AOD system 150 as described above. However, one of ordinary skill in the art will recognize that the method 275 could be implemented by another system. At a block 280, a model, such as the model 258, is trained. For example, the model could be trained using the independent load variable X and the dependent variable Y data sets to configure it to model the dependent gain and heat transfer variables as a function of the load variable. The model could include multiple regression models that each model the gain and heat transfer variables as a function of the load variable for a different range of the load variable.

At a block 284, the trained model generates predicted values (y_{P1}, y_{P2}) of the dependent gain and heat transfer values using values (x) of the independent load variable, total feed rate (Fₜₒₜ), that it receives. Next, at a block 288, the monitored values (y₁, y₂) of the gain and heat transfer variable are compared to the corresponding predicted values (y_{P1}, y_{P2}) to determine if the gain and/or heat transfer is significantly deviating from the predicted values. For example, the deviation detector 262 generates or receives the output (y_{P1}, Y_{P2}) of the model 258 and compares it to the respective values (y₁, y₂) of gain and heat transfer. If it is determined that the gain and/or heat transfer has significantly deviated from (y_{P1}, y_{P2}), an indicator of the deviation may be generated at a block 292. In the AOD system 150, for example, the deviation detector 262 may generate the indicator. The indicator may be an alert or alarm, for example, or any other type of signal, flag, message, etc., indicating that a significant deviation has been detected (e.g., status=“Down”).

As will be discussed in more detail below, the block 280 may be repeated after the model has been initially trained and after it has generated predicted values (y_{P1}, y_{P2}) of the dependent gain and/or heat transfer values. For example, the model could be retrained if a set point in the process has been changed or if a value of the independent load variable falls outside of the range x_{MIN}, x_{MAX}.

Overview of the Regression Model

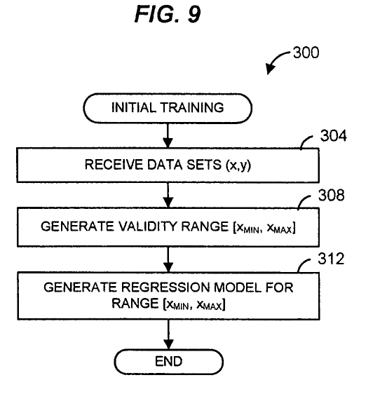

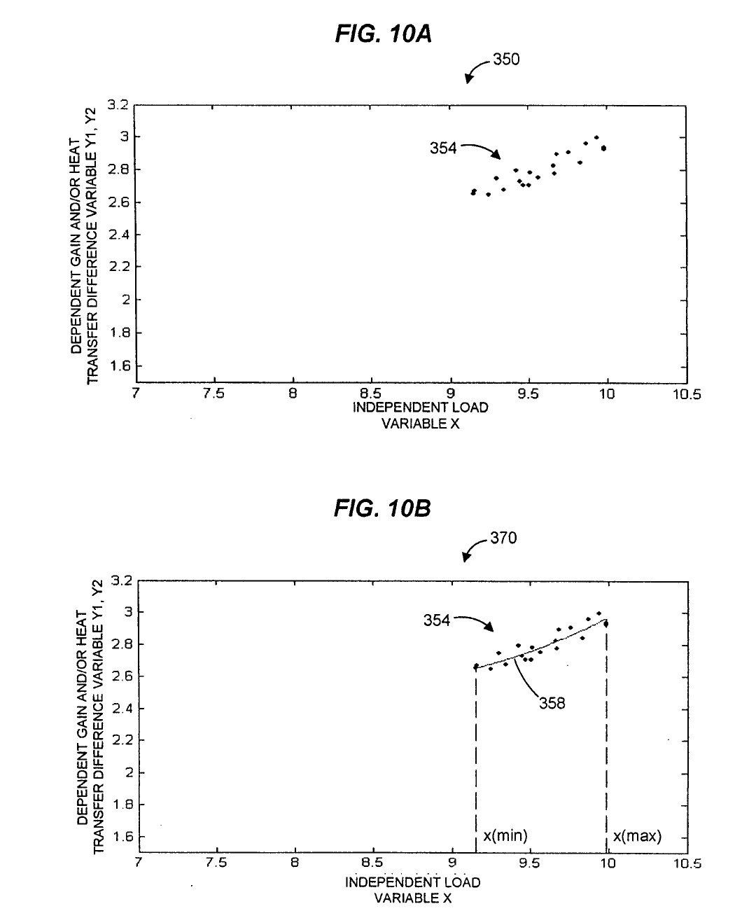

FIG. 9 is a flow diagram of an example method 300 for initially training a model such as the model 258 of FIG. 7. The training of the model 258 may be referred to as a LEARNING state, as described further below. At a block 304, at least an adequate number of data sets (x, y) for the independent load variable X (Fₜₒₜ) and the dependent gain and/or heat transfer variable Y may be received in order to train a model. As described above, the data sets (x, y) may comprise monitored variable (gain and/or heat transfer) and load variable (Fₜₒₜ) data, monitored and load variable data that has been filtered or otherwise processed, statistical data generated from the monitored variable and load variable data, etc. In the AOD system 150 of FIGS. 4-7, the model 258 may receive data sets (x, y) from the SPM blocks 250, 254. Referring now to FIG. 10A, a graph 350 shows an example of a plurality of data sets (x, y) received by a model, and illustrating the AOD system 150 in the LEARNING state while the model is being initially trained. In particular, the graph 350 of FIG. 10A includes a group 354 of data sets that have been collected.

Referring again to FIG. 9, at a block 308, a validity range [x_{MIN}, x_{MAX}] for the model may be generated. The validity range may indicate a range of the independent load variable X for which the model is valid. For instance, the validity range may indicate that the model is valid only for load variable X values in which (x) is greater than or equal to xₘᵢₙ and less than or equal to x_{MAX}. As just one example, x_{MIN} could be set as the smallest value of the load variable in the data sets (x, y) received at the block 304, and x_{MAX} could be set as the largest value of the load variable in the data sets (x, y) received at the block 304. Referring again to FIG. 10A, x_{MIN} could be set to the load variable value of the leftmost data set, and x_{MAX} could be set as the load variable value of the rightmost data set, for example. Of course, the determination of validity range could be implemented in other ways as well. In the AOD system 150 of FIGS. 4-7, the model block 258 could generate the validity range.

At a block 312, a regression model for the range [x_{MIN}, x_{MAX}] may be generated based on the data sets (x, y) received at the block 304. In an example described further below, after a MONITOR command is issued, or if a maximum number of data sets has been collected, a regression model corresponding to the group 354 of data sets may be generated. Any of a variety of techniques, including known techniques, may be used to generate the regression model, and any of a variety of functions could be used as the model. For example, the model of could comprise a linear equation, a quadratic equation, a higher order equation, etc. The graph 370 of FIG. 10B includes a curve 358 superimposed on the data sets (x, y) received at the block 304 illustrates a regression model corresponding to the group 354 of data sets to model the data sets (x, y). The regression model corresponding to the curve 358 is valid in the range [x_{MIN}, x_{MAX}], In the AOD system 150 of FIGS. 4-7, the model block 258 could generate the regression model for the range [x_{MIN}, x_{MAX}].

Utilizing the Model through Operating Region Changes

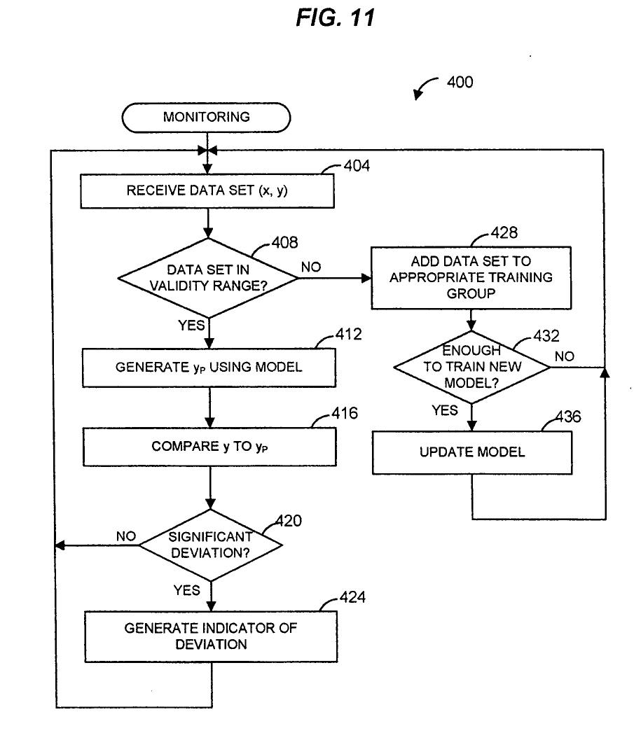

It may be that, after the model has been initially trained, the system that it models may move into a different, but normal operating region. For example, a set point may be changed. FIG. 11 is a flow diagram of an example method 400 for using a model to determine whether abnormal operation is occurring, has occurred, or may occur, wherein the model may be updated if the modeled process moves into a different operating region. The method 400 may be implemented by an AOD system such as the AOD system 150 of FIGS. 4-7. Of course, the method 400 could be implemented by other types of AOD systems as well. The method 400 may be implemented after an initial model has been generated. The method 300 of FIG. 9, for example, could be used to generate the initial model.

At a block 404, a data set (x, y) is received. In the AOD system 150 of FIGS. 4-7, the model 258 could receive a data set (x, y) from the SPM blocks 250, 254, for example. Then, at a block 408, it may be determined whether the data set (x, y) received at the block 404 is in a validity range. The validity range may indicate a range in which the model is valid. In the AOD system 150 of FIGS. 4-7, the model 258 could examine the load variable value (x) received at block 404 to determine if it is within the validity range [x_{MIN}, x_{MAX}]. If it is determined that the data set (x, y) received at block 404 is in the validity range, the flow may proceed to block 412.

At the block 412, a predicted value of either or both of gain and heat transfer (y_{P1}, y_{P2}) of the dependent monitored variable Y may be generated using the model. In particular, the model generates the predicted gain and heat transfer (y_{P1}, y_{P2}) values from the total flow rate (Fₜₒₜ) load variable value (x) received at the block 404. In the AOD system 150 of FIGS. 4-7, the model 258 generates the predicted values (y_{P1}, y_{P2}) from the load variable value (x) received from the SPM block 250.

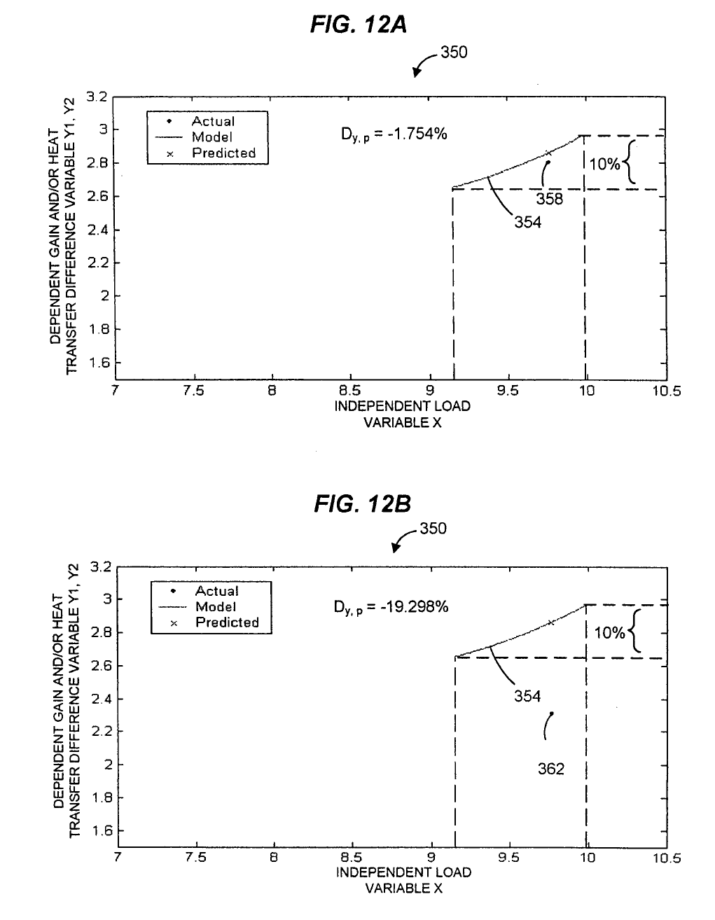

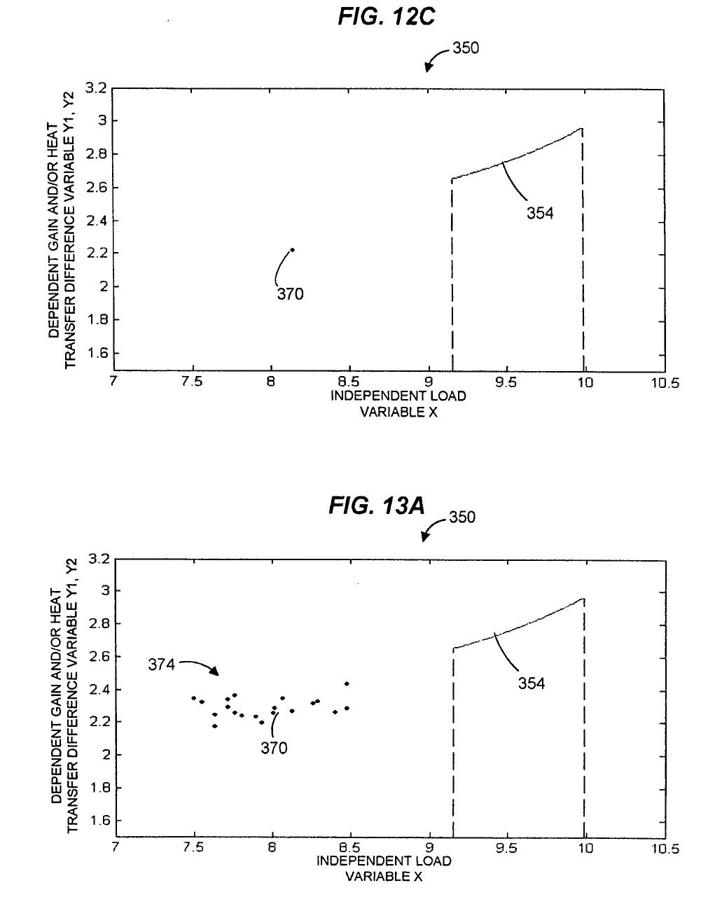

Then, at a block 416, the monitored gain and/or heat transfer values (y₁, y₂) received at the block 404 may be compared with the predicted gain and/or heat transfer values (y_{P1}, y_{P2}). The comparison may be implemented in a variety of ways. For example, a difference or a percentage difference could be generated. Other types of comparisons could be used as well. Referring now to FIG. 12A, an example received data set is illustrated in the graph 350 as a dot 358, and the corresponding predicted value, (y_{P}), is illustrated as an “x”. The graph 350 of FIG. 12A illustrates operation of the AOD system 150 in the MONITORING state. The model generates the prediction (y_{P}) using the regression model indicated by the curve 354. As illustrated in FIG. 12A, it has been calculated that the difference between the monitored gain and/or heat transfer value (y) received at the block 404 and the predicted gain and/or heat transfer value (y_{P}) is −1.754%. Referring now to FIG. 12B, another example received data set is illustrated in the graph 350 as a dot 362, and the corresponding predicted gain and/or heat transfer value, (y_{P}), is illustrated as an “x”. As illustrated in FIG. 12B, it has been calculated that the difference between the monitored variable value (y) received at the block 404 and the predicted value (y_{P}) is −19.298%. In the AOD system 150 of FIGS. 4-7, the deviation detector 262 may perform the comparison.

Referring again to FIG. 11, at a block 420, it may be determined whether the gain and/or heat transfer value (y) received at the block 404 significantly deviates from the predicted gain and/or heat transfer value (y_{P}) based on the comparison of the block 416. The determination at the block 420 may be implemented in a variety of ways and may depend upon how the comparison of the block 416 was implemented. For example, if a gain and/or heat transfer value was generated at the block 412, it may be determined whether this difference value exceeds some threshold. The threshold may be a predetermined or configurable value. Also, the threshold may be constant or may vary. For example, the threshold may vary depending upon the value of the independent load variable X (Fₜₒₜ) value received at the block 404. As another example, if a percentage difference value was generated at the block 412, it may be determined whether this percentage value exceeds some threshold percentage, such as by more than a certain percentage of the predicted gain and/or heat transfer value (y_{P}). As yet another example, a significant deviation may be determined only if two or some other number of consecutive comparisons exceed a threshold. As still another example, a significant deviation may be determined only if the monitored variable value (y) exceeds the predicted variable value (y_{P}) by more than a certain number of standard deviations (σ) of the predicted variable value (y_{P}). The standard deviation(s) may be modeled as a function of the load variable X or calculated from the variable of the residuals of the training data. A common or a different threshold may be used for each of the gain and/or heat transfer values.

Referring again to FIG. 12A, the difference between the monitored gain and/or heat transfer value (y) received at the block 404 and the predicted value (y_{P}) is −1.754%. If, for example, a threshold of 10% is to be used to determine whether a deviation is significant, the absolute value of the difference illustrated in FIG. 12A is below that threshold. Referring again to FIG. 12B on the other hand, the difference between the monitored gain and/or heat transfer value (y) received at the block 404 and the predicted gain and/or heat transfer value (y_{P}) is −19.298%. The absolute value of the difference illustrated in FIG. 12B is above the threshold value 10%, so an abnormal condition indicator may be generated as will be discussed below. In the AOD system 150 of FIGS. 4-7, the deviation detector 262 may implement the block 420.

In general, determining if the monitored gain and/or heat transfer value (y) significantly deviates from the predicted gain and/or heat transfer value (y_{P}) may be implemented using a variety of techniques, including known techniques. In one implementation, determining if the monitored gain and/or heat transfer value (y) significantly deviates from the predicted gain and/or heat transfer value (y_{P}) may include analyzing the present values of (y) and (y_{P}). For example, the monitored gain and/or heat transfer value (y) could be subtracted from the predicted gain and/or heat transfer value (y_{P}), or vice versa, and the result may be compared to a threshold to see if it exceeds the threshold. It may optionally comprise also analyzing past values of (y) and (y_{P}). Further, it may comprise comparing (y) or a difference between (y) and (y_{P}) to one or more thresholds. Each of the one or more thresholds may be fixed or may change. For example, a threshold may change depending on the value of the load variable X or some other variable. Different thresholds may be used for different gain and/or heat transfer values. U.S. patent application Ser. No. 11/492,347, entitled “Methods And Systems For Detecting Deviation Of A Process Variable From Expected Values,” filed on Jul. 25, 2006, and which was incorporated by reference above, describes example systems and methods for detecting whether a process variable significantly deviates from an expected value, and any of these systems and methods may optionally be utilized. One of ordinary skill in the art will recognize many other ways of determining if the monitored gain and/or heat transfer value (y) significantly deviates from the predicted value (y_{P}). Further, blocks 416 and 420 may be combined.

Some or all of criteria to be used in the comparing (y) to (y_{P}) (block 416) and/or the criteria to be used in determining if (y) significantly deviates from (y_{P}) (block 420) may be configurable by a user via the configuration application 38 (FIGS. 1 and 2). For instance, the type of comparison (e.g., generate difference, generate absolute value of difference, generate percentage difference, etc.) may be configurable. Also, the threshold or thresholds to be used in determining whether the deviation is significant may be configurable by an operator or by another algorithm. Alternatively, such criteria may not be readily configurable.

Referring again to FIG. 11, if it is determined that the monitored gain and/or heat transfer value (y) received at the block 404 does not significantly deviate from the predicted value (y_{P}), the flow may return to the block 404 to receive the next data set (x, y). If, however, it is determined that the gain and/or heat transfer value (y) does significantly deviate from the predicted value (y_{P}), the flow may proceed to the block 424. At the block 424, an indicator of a deviation may be generated. The indicator may be an alert or alarm, for example. The generated indicator may include additional information such as whether the value (y) received at the block 404 was higher than expected or lower than expected, for example. Referring to FIG. 12A, because the difference between the gain and/or heat transfer value (y) received at the block 404 and the predicted value (y_{P}) is −1.754%, which is below the threshold 10%, no indicator is generated. On the other hand, referring to FIG. 12B, the difference between (y) received at the block 404 and the predicted value (y_{P}) is −19.298%, which is above the threshold 10%. Therefore, an indicator is generated. In the AOD system 150 of FIGS. 4-7, the deviation detector 262 may generate the indicator.

Referring again to the block 408 of FIG. 11, if it is determined that the data set (x, y) received at the block 404 is not in the validity range, the flow may proceed to a block 428. However, the models developed by the AOD system 150 are generally valid for the range of data for which the model was trained. If the load variable X goes outside of the limits for the model as illustrated by the curve 354, the status is out of range, and the AOD system 150 would be unable to detect the abnormal condition. For example, in FIG. 12C, the AOD system 150 receives a data set illustrated as a dot 370 that is not within the validity range. This may cause the AOD system 150 to transition to an OUT OF RANGE state, in which case, the AOD system 150 may transition again to the LEARNING state, either in response to an operator command or automatically. As such, after the initial learning period, if the process moves to a different operating region, it remains possible for the AOD system to learn a new model for the new operating region while keeping the model for the original operating range.

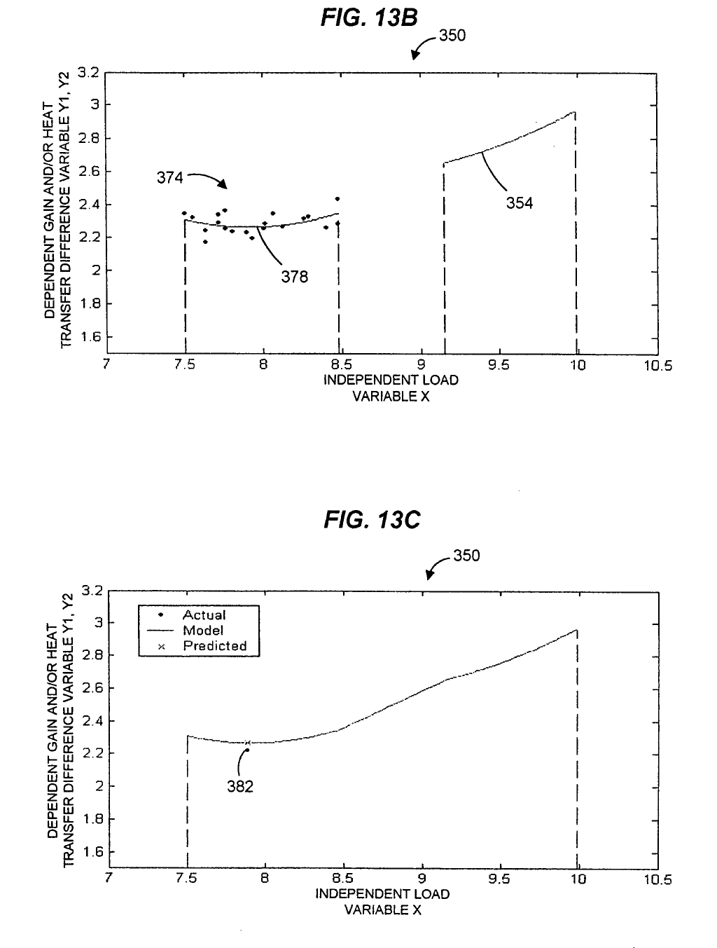

Referring now to FIG. 13A, it shows a graph further illustrating received data sets 370 that are not in the validity range when the AOD system 150 transitions back to a LEARNING state. In particular, the graph of FIG. 13A includes a group 374 of data sets that have been collected. Referring again to FIG. 11, at the block 428, the data set (x, y) received at the block 404 may be added to an appropriate group of data sets that may be used to train the model at a subsequent time. Referring to FIG. 13A, the data set 370 has been added to the group of data sets 374 corresponding to data sets in which the value of X is less than x_{MIN}. For example, if the value of the load variable X received at the block 404 is less than x_{MIN}, the data set (x, y) received at the block 404 may be added to a data group corresponding to other received data sets in which the value of the load variable X is less than x_{MIN}. Similarly, if the value of the load variable value X received at the block 404 is greater than x_{MAX}, the data set (x, y) received at the block 404 may be added to a data group corresponding to other received data sets in which the value of the load variable value is greater than x_{MAX}. In the AOD system 150 of FIGS. 4-7, the model block 258 may implement the block 428.

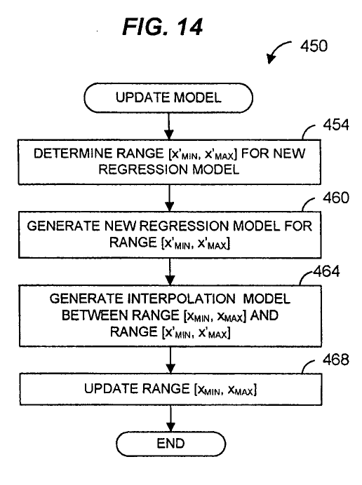

Then, at a block 432, it may be determined if enough data sets are in the data group to which the data set was added at the block 428 in order to generate a regression model corresponding to the group 374 of data sets. This determination may be implemented using a variety of techniques. For example, the number of data sets in the group may be compared to a minimum number, and if the number of data sets in the group is at least this minimum number, it may be determined that there are enough data sets in order to generate a regression model. The minimum number may be selected using a variety of techniques, including techniques known to those of ordinary skill in the art. If it is determined that there are enough data sets in order to generate a regression model, the model may be updated at a block 436, as will be described below with reference to FIG. 14. If it is determined, however, that there are not enough data sets in order to generate a regression model, the flow may return to the block 404 to receive the next data set (x, y). In another example, an operator may cause a MONITOR command to be issued in order to cause the regression model to be generated.

FIG. 14 is a flow diagram of an example method 450 for updating the model after it is determined that there are enough data sets in a group in order to generate a regression model for data sets outside the current validity range [x_{MIN}, x_{MAX}]. At a block 454, a range [x′_{MIN}, x′_{MAX}] for a new regression model may be determined. The validity range may indicate a range of the independent load variable X for which the new regression model will be valid. For instance, the validity range may indicate that the model is valid only for load variable values (x) in which (x) is greater than or equal to x′_{MIN} and less than or equal to x′_{MAX}. As just one example, x′_{MIN} could be set as the smallest value of load variable X in the group of data sets (x, y), and x′_{MAX} could be set as the largest value of load variable X in the group of data sets (x, y). Referring again to FIG. 13A, x′_{MIN} could be set to the load variable value (x) of the leftmost data set in the group 374, and x′_{MAX} could be set as the load variable value (x) of the rightmost data set in the group 374, for example. In the AOD system 150 of FIGS. 4-7, the model block 258 could generate the validity range.

At a block 460, a regression model for the range [x′_{MIN}, x′_{MAX}] may be generated based on the data sets (x, y) in the group. Any of a variety of techniques, including known techniques, may be used to generate the regression model, and any of a variety of functions could be used as the model. For example, the model could comprise a linear equation, a quadratic equation, etc. In FIG. 13B, a curve 378 superimposed on the group 374 illustrates a regression model that has been generated to model the data sets in the group 374. The regression model corresponding to the curve 378 is valid in the range [x′_{MIN}, x′_{MAX}], and the regression model corresponding to the curve 354 is valid in the range [x_{MIN}, x_{MAX}]. In the AOD system 150 of FIGS. 4-7, the model 258 could generate the regression model for the range [x′_{MIN}, x′_{MAX}].

For ease of explanation, the range [x_{MIN}, x_{MAX}] will now be referred to as [x_{MIN}_{_{—}}₁, x_{MAX}_{_{—}}₁], and the range [x′_{MIN}, x′_{MAX}] will now be referred to as [x_{MIN}_{_{—}}₂, x_{MAX}_{_{—}}₂]. Additionally, the regression model corresponding to the range [x_{MIN}_{_{—}}₁, x_{MAX}_{_{—}}₁] will be referred to as f₁(x), and regression model corresponding to the range [x_{MIN}_{_{—}}2, x_{MAX}_{_{—}}₂] will be referred to as f₂(x). Thus, the model may now be represented as:

$$f ( x ) = \{ \begin{matrix}{f}_{1} ( x ) & for {x}_{MIN\_ 1} \leq x \leq {x}_{MAX\_ 1} \\ {f}_{2} ( x ) & for {x}_{MIN\_ 2} \leq x \leq {x}_{MAX\_ 2}\end{matrix} \qquad ( Equ . 1 )$$

Referring again to FIG. 14, at a block 464, an interpolation model may be generated between the regression models corresponding to the ranges [x_{MIN}_{_{—}}₁, x_{MAX}_{_{—}}₁] and [x_{MIN}_{_{—}}₂, x_{MAX}_{_{—}}₂] for the operating region between the curves 354 and 378. The interpolation model described below comprises a linear function, but in other implementations, other types of functions, such as a quadratic function, can be used. If x_{MAX}_{_{—}}₁ is less than x_{MIN}_{_{—}}₂, then the interpolation model may be calculated as:

$$( \frac{{f}_{2} ( {x}_{MIN\_ 2} ) - {f}_{1} ( {x}_{MAX\_ 1} )}{{x}_{MIN\_ 2} - {x}_{MAX\_ 1}} ) ( x - {x}_{MIN\_ 2} ) + {f}_{2} ( {x}_{MIN\_ 2} ) \qquad ( Equ . 2 )$$

Similarly, if x_{MAX}_{_{—}}₂ is less than x_{MIN}_{_{—}}₁, then the interpolation model may be calculated as:

$$( \frac{{f}_{1} ( {x}_{MIN\_ 1} ) - {f}_{2} ( {x}_{MAX\_ 2} )}{{x}_{MIN\_ 1} - {x}_{MAX\_ 2}} ) ( x - {x}_{MIN\_ 1} ) + {f}_{1} ( {x}_{MIN\_ 1} ) \qquad ( Equ . 3 )$$

Thus, the model may now be represented as:

$$f ( x ) = \{ \begin{matrix}{f}_{1} ( x ) & for {x}_{MIN\_ 1} \leq x \leq {x}_{MAX\_ 1} \\ ( \frac{{f}_{2} ( {x}_{MIN\_ 2} ) - {f}_{1} ( {x}_{MAX\_ 1} )}{{x}_{MIN\_ 2} - {x}_{MAX\_ 1}} ) ( x - {x}_{MIN\_ 2} ) + {f}_{2} ( {x}_{MIN\_ 2} ) & for {x}_{MAX\_ 1} < x < {x}_{MIN\_ 2} \\ {f}_{2} ( x ) & for {x}_{MIN\_ 2} \leq x \leq {x}_{MAX\_ 2}\end{matrix} \qquad ( Equ . 4 )$$

may be represented as:

$$f ( x ) = \{ \begin{matrix}{f}_{2} ( x ) & for {x}_{MIN\_ 2} \leq x \leq {x}_{MAX\_ 2} \\ ( \frac{{f}_{2} ( {x}_{MIN\_ 1} ) - {f}_{1} ( {x}_{MAX\_ 2} )}{{x}_{MIN\_ 1} - {x}_{MAX\_ 2}} ) ( x - {x}_{MIN\_ 1} ) + {f}_{1} ( {x}_{MIN\_ 1} ) & for {x}_{MAX\_ 2} < x < {x}_{MIN\_ 1} \\ {f}_{1} ( x ) & for {x}_{MIN\_ 1} \leq x \leq {x}_{MAX\_ 1}\end{matrix} \qquad ( Equ . 5 )$$

As can be seen from equations 1, 4 and 5, the model may comprise a plurality of regression models. In particular, a first regression model (i.e., f₁(x)) may be used to model the dependent gain and/or heat transfer value Y in a first operating region (i.e., x_{MIN}_{_{—}}₁≦x≦x_{MAX}_{_{—}}₁), and a second regression model (i.e., f₂(x)) may be used to model the dependent gain and/or heat transfer value Y in a second operating region (i.e., x_{MIN}_{_{—}}₂≦x≦x_{MAX}_{_{—}}₂). Additionally, as can be seen from equations 4 and 5, the model may also comprise an interpolation model to model the dependent gain and/or heat transfer value Y in between operating regions corresponding to the regression models.

Referring again to FIG. 14, at a block 468, the validity range may be updated. For example, if x_{MAX}_{_{—}}₁ is less than x_{MIN}_{_{—}}₂, then x_{MIN} may be set to x_{MIN}_{_{—}}₁ and x_{MAX} may be set to x_{MAX}_{_{—}}₂. Similarly, if x_{MAX}_{_{—}}₂ is less than x_{MIN}_{_{—}}₁, then x_{MIN} may be set to x_{MIN}_{_{—}}₂ and x_{MAX} may be set to x_{MAX}_{_{—}}₁. FIG. 13C illustrates the new model with the new validity range. Referring to FIGS. 11 and 14, the model may be updated a plurality of times using a method such as the method 450. As seen from FIG. 13C, the original model is retained for the original operating range, because the original model represents the “normal” value for the gain and/or heat transfer value Y. Otherwise, if the original model were continually updated, there is a possibility that the model would be updated to a faulty condition and an abnormal situation would not be detected. When the process moves into a new operation region, it may be assumed that the process is still in a normal condition in order to develop a new model, and the new model may be used to detect further abnormal situations in the system that occur in the new operating region. As such, the model for the coker heater 64 may be extended indefinitely as the process model to different operating regions.

The abnormal situation prevention system 35 (FIGS. 1 and 2) may cause, for example, graphs similar to some or all of the graphs illustrated in FIGS. 10A, 10B, 12A, 12B, 12C, 13A, 13B, 13C to be displayed on a display device. For instance, if the AOD system 150 provides model criteria data to the abnormal situation prevention system 35 or a database, for example, the abnormal situation prevention system 35 may use this data to generate a display illustrating how the model 258 is modeling the dependent gain and/or heat transfer variable Y as a function of the independent Fₜₒₜ load variable X. For example, the display may include a graph similar to one or more of the graphs of FIGS. 10A, 10B and 13C. Optionally, the AOD system 150 may also provide the abnormal situation prevention system 35 or a database, for example, with some or all of the data sets used to generate the model 258. In this case, the abnormal situation prevention system 35 may use this data to generate a display having a graph similar to one or more of the graphs of FIGS. 10A, 10B, 13A, 13B. Optionally, the AOD system 150 may also provide the abnormal situation prevention system 35 or a database, for example, with some or all of the data sets that the AOD system 150 is evaluating during its monitoring phase. Additionally, the AOD system 150 may also provide the abnormal situation prevention system 35 or a database, for example, with the comparison data for some or all of the data sets. In this case, as just one example, the abnormal situation prevention system 35 may use this data to generate a display having a graph similar to one or more of the graphs of FIGS. 10A and 10B.

Manual Control of AOD System

In the AOD systems described with respect to FIGS. 9, 11, and 14, the model may automatically update itself when enough data sets have been obtained in a particular operating region. However, it may be desired that such updates do not occur unless a human operator permits it. Additionally, it may be desired to allow a human operator to cause the model to update even when received data sets are in a valid operating region.

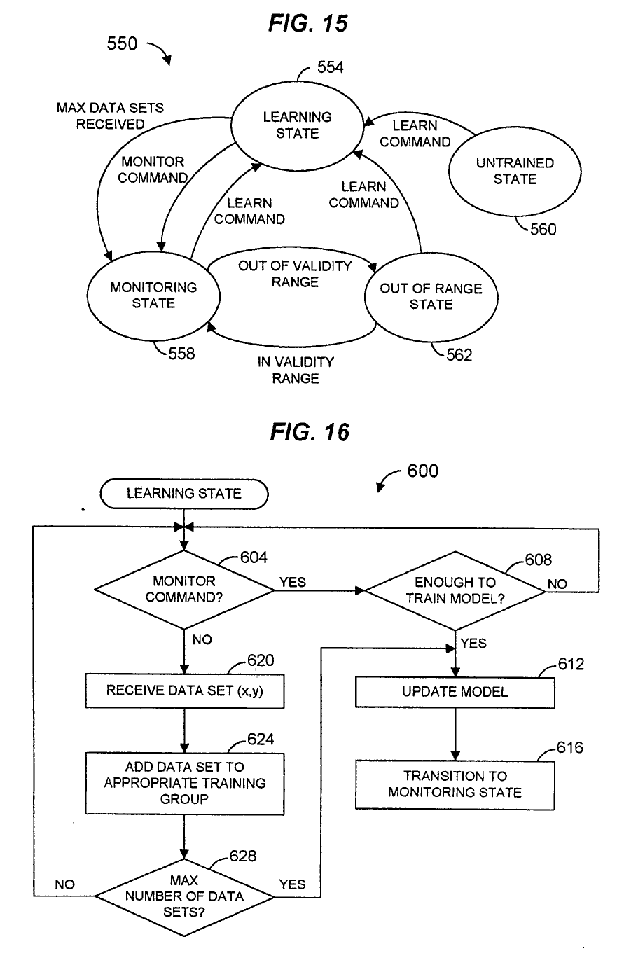

FIG. 15 is an example state transition diagram 550 corresponding to an alternative operation of an AOD system such as the AOD system 150 of FIGS. 4-7. The operation corresponding to the state diagram 550 allows a human operator more control over the AOD system. For example, as will be described in more detail below, an operator may cause a LEARN command to be sent to the AOD system 150 when the operator desires that the model of the AOD system be forced into a LEARNING state 554. Generally speaking, in the LEARNING state 554, which will be described in more detail below, the AOD system obtains data sets for generating a regression model. Similarly, when the operator desires that the AOD system create a regression model and begin monitoring incoming data sets, the operator may cause a MONITOR command to be sent to the AOD system. Generally speaking, in response to the MONITOR command, the AOD system may transition to a MONITORING state 558.

An initial state of the AOD system may be an UNTRAINED state 560, for example. The AOD system may transition from the UNTRAINED state 560 to the LEARNING state 554 when a LEARN command is received. If a MONITOR command is received, the AOD system may remain in the UNTRAINED state 560. Optionally, an indication may be displayed on a display device to notify the operator that the AOD system has not yet been trained.

In an OUT OF RANGE state 562, each received data set may be analyzed to determine if it is in the validity range. If the received data set is not in the validity range, the AOD system may remain in the OUT OF RANGE state 562. If, however, a received data set is within the validity range, the AOD system may transition to the MONITORING state 558. Additionally, if a LEARN command is received, the AOD system may transition to the LEARNING state 554.

In the LEARNING state 554, the AOD system may collect data sets so that a regression model may be generated in one or more operating regions corresponding to the collected data sets. Additionally, the AOD system optionally may check to see if a maximum number of data sets has been received. The maximum number may be governed by storage available to the AOD system, for example. Thus, if the maximum number of data sets has been received, this may indicate that the AOD system is, or is in danger of, running low on available memory for storing data sets, for example. In general, if it is determined that the maximum number of data sets has been received, or if a MONITOR command is received, the model of the AOD system may be updated and the AOD system may transition to the MONITORING state 558.

FIG. 16 is a flow diagram of an example method 600 of operation in the LEARNING state 554. At a block 604, it may be determined if a MONITOR command was received. If a MONITOR command was received, the flow may proceed to a block 608. At the block 608, it may be determined if a minimum number of data sets has been collected in order to generate a regression model. If the minimum number of data sets has not been collected, the AOD system may remain in the LEARNING state 554. Optionally, an indication may be displayed on a display device to notify the operator that the AOD system is still in the LEARNING state because the minimum number of data sets has not yet been collected.

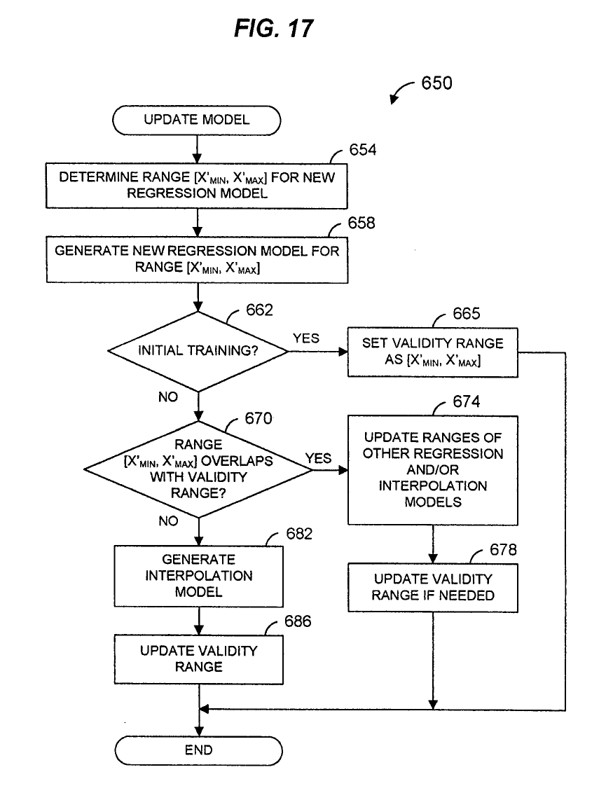

If, on the other hand, the minimum number of data sets has been collected, the flow may proceed to a block 612. At the block 612, the model of the AOD system may be updated as will be described in more detail with reference to FIG. 17. Next, at a block 616, the AOD system may transition to the MONITORING state 558.

If, at the block 604 it has been determined that a MONITOR command was not received, the flow may proceed to a block 620, at which a new data set may be received. Next, at a block 624, the received data set may be added to an appropriate training group. An appropriate training group may be determined based on the load variable value of the data set, for instance. As an illustrative example, if the load variable value is less than x_{MIN} of the model's validity range, the data set could be added to a first training group. And, if the load variable value is greater than x_{MAX} of the model's validity range, the data set could be added to a second training group.

At a block 628, it may be determined if a maximum number of data sets has been received. If the maximum number has been received, the flow may proceed to the block 612, and the AOD system will eventually transition to the MONITORING state 558 as described above. On the other hand, if the maximum number has not been received, the AOD system will remain in the LEARNING state 554. One of ordinary skill in the art will recognize that the method 600 can be modified in various ways. As just one example, if it is determined that the maximum number of data sets has been received at the block 628, the AOD system could merely stop adding data sets to a training group. Additionally or alternatively, the AOD system could cause a user to be prompted to give authorization to update the model. In this implementation, the model would not be updated, even if the maximum number of data sets had been obtained, unless a user authorized the update.

FIG. 17 is a flow diagram of an example method 650 that may be used to implement the block 612 of FIG. 16. At a block 654, a range [x′_{MIN}, x′_{MAX}] may be determined for the regression model to be generated using the newly collected data sets. The range [x′_{MIN}, x′_{MAX}] may be implemented using a variety of techniques, including known techniques. At a block 658, the regression model corresponding to the range [x′_{MIN}, x′_{MAX}] may be generated using some or all of the data sets collected and added to the training group as described with reference to FIG. 16. The regression model may be generated using a variety of techniques, including known techniques.

At a block 662, it may be determined if this is the initial training of the model. As just one example, it may be determined if the validity range [x_{MIN}, x_{MAX}] is some predetermined range that indicates that the model has not yet been trained. If it is the initial training of the model, the flow may proceed to a block 665, at which the validity range [x_{MIN}, x_{MAX}] will be set to the range determined at the block 654.

If at the block 662 it is determined that this is not the initial training of the model, the flow may proceed to a block 670. At the block 670, it may be determined whether the range [x′_{MIN}, x′_{MAX}] overlaps with the validity range [x_{MIN}, x_{MAX}]. If there is overlap, the flow may proceed to a block 674, at which the ranges of one or more other regression models or interpolation models may be updated in light of the overlap. Optionally, if a range of one of the other regression models or interpolation models is completely within the range [x′_{MIN}, x′_{MAX}], the other regression model or interpolation model may be discarded. This may help to conserve memory resources, for example. At a block 678, the validity range may be updated, if needed. For example, if x′_{MIN} is less than x_{MIN} of the validity range, x_{MIN} of the validity range may be set to the x′_{MIN}.

If at the block 670 it is determined that the range [x′_{MIN}, x′_{MAX}] does not overlap with the validity range [x_{MIN}, x_{MAX}], the flow may proceed to a block 682. At the block 682, an interpolation model may be generated, if needed. At the block 686, the validity range may be updated. The blocks 682 and 686 may be implemented in a manner similar to that described with respect to blocks 464 and 468 of FIG. 14.

One of ordinary skill in the art will recognize that the method 650 can be modified in various ways. As just one example, if it is determined that the range [x′_{MIN}, x′_{MAX}] overlaps with the validity range [x_{MIN}, x_{MAX}], one or more of the range [x′_{MIN}, x′_{MAX}] and the operating ranges for the other regression models and interpolation models could be modified so that none of these ranges overlap.

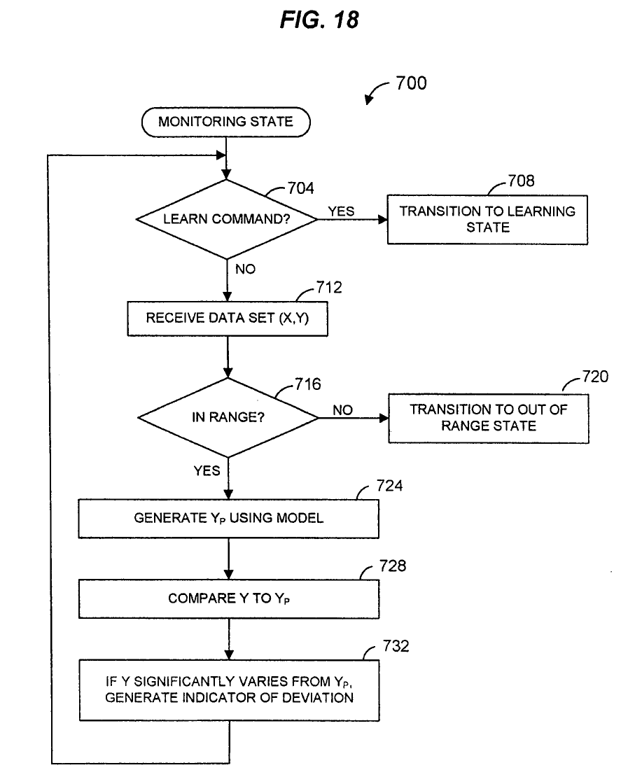

FIG. 18 is a flow diagram of an example method 700 of operation in the MONITORING state 558. At a block 704, it may be determined if a LEARN command was received. If a LEARN command was received, the flow may proceed to a block 708. At the block 708, the AOD system may transition to the LEARNING state 554. If a LEARN command was not received, the flow may proceed to a block 712.

At the block 712, a data set (x, y) may be received as described previously. Then, at a block 716, it may be determined whether the received data set (x, y) is within the validity range [x_{MIN}, x_{MAX}]. If the data set is outside of the validity range [x_{MIN}, x_{MAX}], the flow may proceed to a block 720, at which the AOD system may transition to the OUT OF RANGE state 562. But if it is determined at the block 716 that the data set is within the validity range [x_{MIN}, x_{MAX}], the flow may proceed to blocks 724, 728 and 732. The blocks 724, 728 and 732 may be implemented similarly to the blocks 284, 288 and 292, respectively, as described with reference to FIG. 8.

To help further explain state transition diagram 550 of FIG. 15, the flow diagram 600 of FIG. 16, the flow diagram 650 of FIG. 17, and the flow diagram 700 of FIG. 18, reference is again made to FIGS. 10A, 10B, 12A, 12B, 12C, 13A, 13B, 13C. FIG. 10A shows the graph 350 illustrating the AOD system in the LEARNING state 554 while its model is being initially trained. In particular, the graph 350 of FIG. 10A includes the group 354 of data sets that have been collected. After an operator has caused a MONITOR command to be issued, or if a maximum number of data sets has been collected, a regression model corresponding to the group 354 of data sets may be generated. The graph 350 of FIG. 10B includes a curve 358 indicative of the regression model corresponding to the group 354 of data sets. Then, the AOD system may transition to the MONITORING state 558.

The graph 350 of FIG. 12A illustrates operation of the AOD system in the MONITORING state 558. In particular, the AOD system receives the data set 358 that is within the validity range. The model generates a prediction y_{P} (indicated by the “x” in the graph of FIG. 12A) using the regression model indicated by the curve 354. In FIG. 12C, the AOD system receives the data set 370 that is not within the validity range. This may cause the AOD system to transition to the OUT OF RANGE state 562.

If the operator subsequently causes a LEARN command to be issued, the AOD system will transition again to the LEARNING state 554. The graph 350 of FIG. 13A illustrates operation of the AOD system after it has transitioned back to the LEARNING state 554. In particular, the graph of FIG. 13A includes the group 374 of data sets that have been collected. After an operator has caused a MONITOR command to be issued, or if a maximum number of data sets has been collected, a regression model corresponding to the group 374 of data sets may be generated. The graph 350 of FIG. 13B includes the curve 378 indicative of the regression model corresponding to the group 374 of data sets. Next, an interpolation model may be generated for the operating region between the curves 354 and 378.

Then, the AOD system may transition back to the MONITORING state 558. The graph 350 of FIG. 13C illustrates the AOD system again operating in the MONITORING state 558. In particular, the AOD system receives the data set 382 that is within the validity range. The model generates a prediction y_{P} (indicated by the “x” in the graph of FIG. 13C) using the regression model indicated by the curve 378 of FIG. 13B.

If the operator again causes a LEARN command to be issued, the AOD system will again transition to the LEARNING state 554, during which a further group of data sets are collected. After an operator has caused a MONITOR command to be issued, or if a maximum number of data sets has been collected, a regression model corresponding to the group of data sets may be generated. Ranges of the other regression models may be updated. For example, the ranges of the regression models corresponding to the curves 354 and 378 may be lengthened or shortened as a result of adding a regression model between the two. Additionally, the interpolation model for the operating region between the regression models corresponding to the curves 354 and 378 are overridden by a new regression model corresponding to a curve between curves 354, 378. Thus, the interpolation model may be deleted from a memory associated with the AOD system if desired. After transitioning to the MONITORING state 558, the AOD system may operate as described previously.

One aspect of the AOD system is the user interface routines which provide a graphical user interface (GUI) that is integrated with the AOD system described herein to facilitate a user's interaction with the various abnormal situation prevention capabilities provided by the AOD system. However, before discussing the GUI in greater detail, it should be recognized that the GUI may include one or more software routines that are implemented using any suitable programming languages and techniques. Further, the software routines making up the GUI may be stored and processed within a single processing station or unit, such as, for example, a workstation, a controller, etc. within the plant 10 or, alternatively, the software routines of the GUI may be stored and executed in a distributed manner using a plurality of processing units that are communicatively coupled to each other within the AOD system.

Preferably, but not necessarily, the GUI may be implemented using a familiar graphical, windows-based structure and appearance, in which a plurality of interlinked graphical views or pages include one or more pull-down menus that enable a user to navigate through the pages in a desired manner to view and/or retrieve a particular type of information. The features and/or capabilities of the AOD system described above may be represented, accessed, invoked, etc. through one or more corresponding pages, views or displays of the GUI. Furthermore, the various displays making up the GUI may be interlinked in a logical manner to facilitate a user's quick and intuitive navigation through the displays to retrieve a particular type of information or to access and/or invoke a particular capability of the AOD system.

Generally speaking, the GUI described herein provides intuitive graphical depictions or displays of process control areas, units, loops, devices, etc. Each of these graphical displays may include status information and indications (some or all of which may be generated by the AOD system described above) that are associated with a particular view being displayed by the GUI. A user may use the indications shown within any view, page or display to quickly assess whether a problem exists within the coker heater 64 or other devices depicted within that display.

Additionally, the GUI may provide messages to the user in connection with a problem, such as an abnormal situation, that has occurred or which may be about to occur within the coker heater 64. These messages may include graphical and/or textual information that describes the problem, suggests possible changes to the system which may be implemented to alleviate a current problem or which may be implemented to avoid a potential problem, describes courses of action that may be pursued to correct or to avoid a problem, etc.

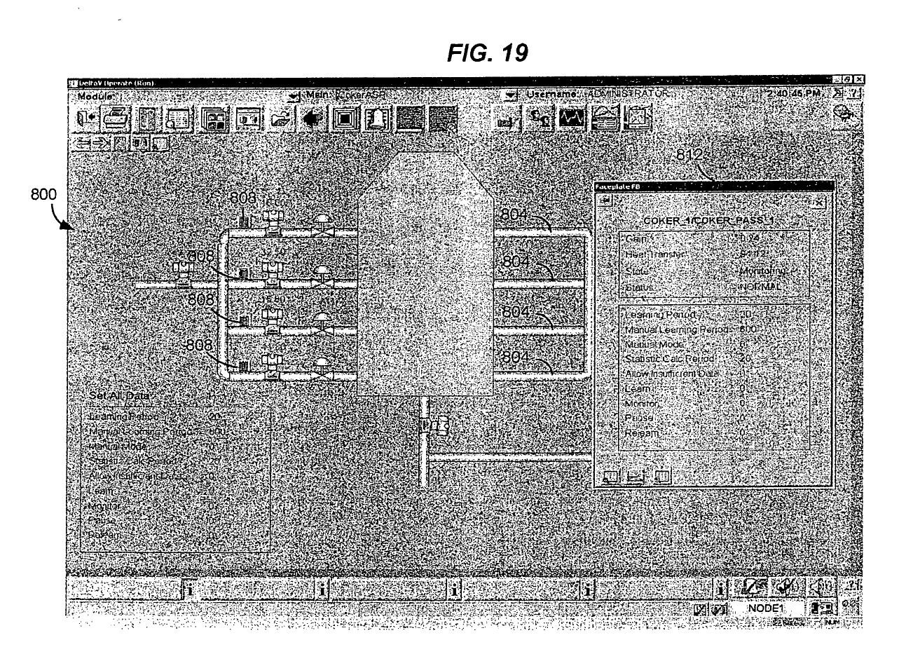

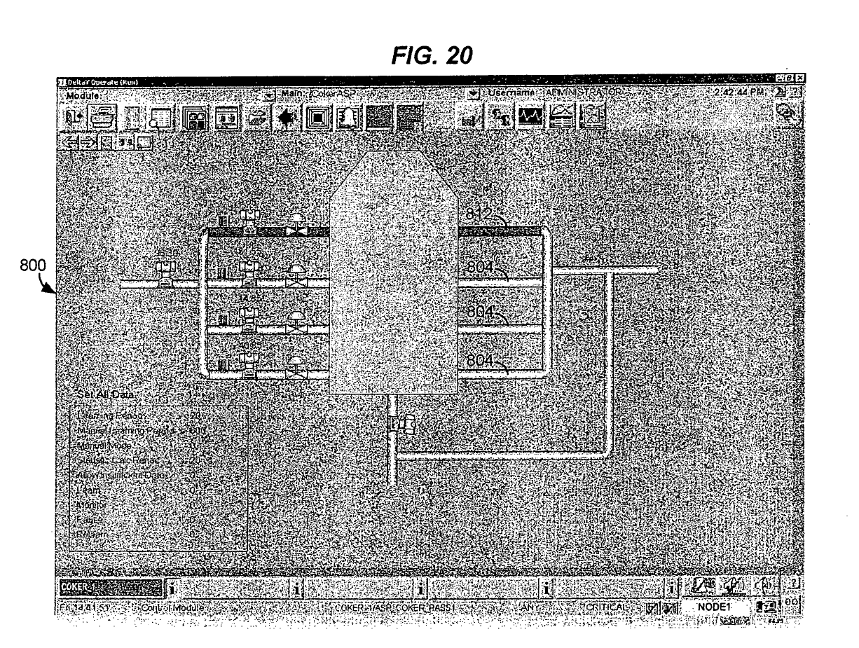

The coker abnormal situation prevention module 300 may include one or more operator displays. FIGS. 19-22 illustrate an example of an operator display 800 for use with an AOD system 150 for abnormal situation prevention in a coker heater 64 of a coking unit 62. With reference to FIG. 19, an operator display 800 may show a number of passes 804 illustrative of the actual coker heater 64 that is being monitored. The display 800 may automatically adjust to illustrate an accurate number of passes 804 for the physical system that the operator display 800 represents. Each pass 804 may include a button 808 or other selectable user interface structure that, when selected by a user, may display information about the portion of the coker heater 64 associated with the button 808 on the display 800. For example, upon selection of a button 808, the display 800 may launch a faceplate 812 that may display information about the pass 804 associated with the selected button 808, or other information related to the operation of the coker heater 64. The faceplate 812 may include a mode, status, current gain, current heat transfer, predicted gain, predicted heat transfer, current regression model(s), quality of regression fit, or any other information related to the process plant 10 and the unit monitored by the AOD system 150. The faceplate 812 may also include user-adjustable controls to modify any configurable parameters of the unit represented in the display 800. For example, through controls within the faceplate, an operator may configure any of a learning mode time period, a statistical calculation period, a regression order, or threshold limits. Further, the operator may take steps to alleviate a detected high coking condition. For example, the operator may modify a flow valve position to increase the flow rate, thereby decreasing the time the feed is present in the conduits in an attempt to reduce coking conditions. Of course, the operator may make many other adjustments to the coker heater to prevent or alleviate an abnormal situation. Other information may also be displayed and other variables configured through the faceplate 812.

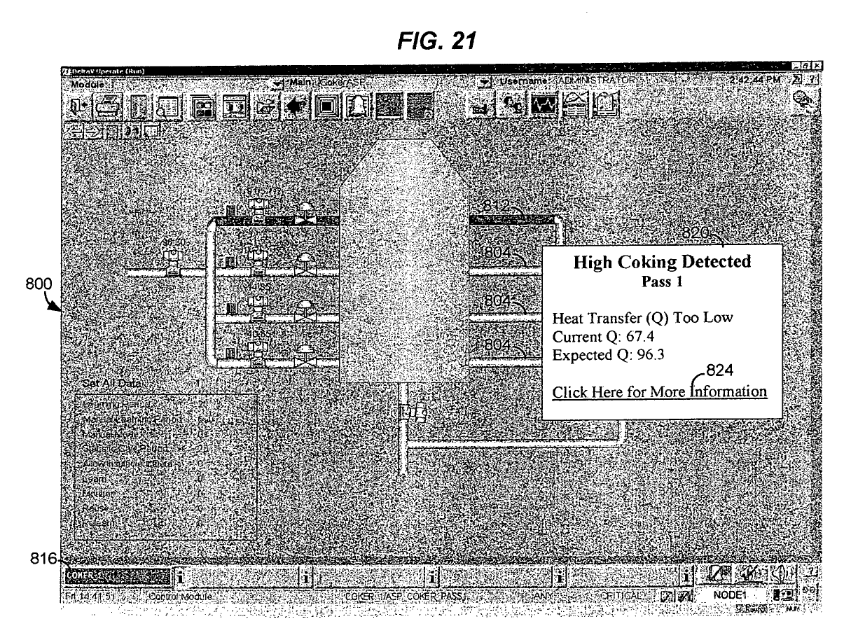

With reference to FIG. 21, the operator display 800 may include additional information regarding a detected abnormal situation. In one embodiment, an operator may select a button, a visual representation of the affected area of the monitored unit, or another structure of the operator display 800 to retrieve information about the situation. For example, an operator may select the visual representation of the affected pass 812, an alarm banner 816, or other structure of the display 800. Upon selection, the display 800 may present a summary message 820 or other information about the specific affected area of the monitored unit.

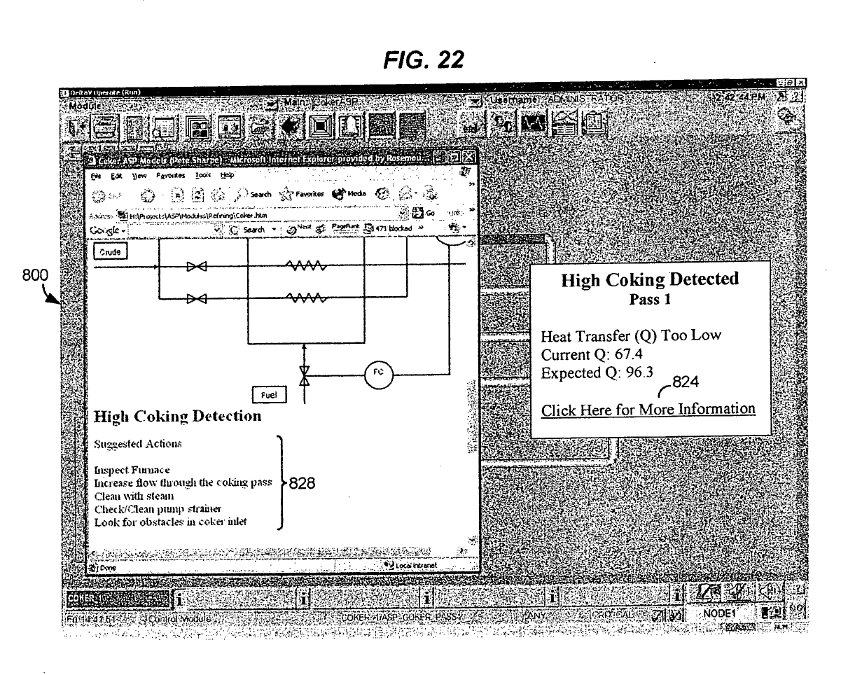

With reference to FIGS. 21 and 22, the summary message 820 may include a further selectable structure 824 (FIG. 21) that may allow presentation of additional, detailed information that may not be included in the summary message. As illustrated in FIG. 22, selection of the structure 824 may present details about the abnormal situation including suggested actions 828 that may indicate a possible remedy for the detected fault. Additionally, upon selection, the structure 824 may present a guided help document which may provide further, in-depth instructions for the operator to correct the abnormal situation.

Based on the foregoing, a system and method to facilitate the monitoring and diagnosis of a process control system may be disclosed with a specific premise of abnormal situation prevention in a coker heater of a coker unit in a product refining process. Monitoring and diagnosis of faults in a coker heater may include statistical analysis techniques, such as regression. In particular, on-line process data is collected from an operating coker heater in a coker area of a refinery. The process data is representative of a normal operation of the process when it is on-line and operating normally. A statistical analysis is used to develop a model of the process based on the collected data. Alternatively, or in conjunction, monitoring of the process may be performed which uses a model of the process developed using statistical analysis to generate an output based on a parameter of the model. The output may use a variety of parameters from the model and may include a statistical output based on the results of the model, and normalized process variables based on the training data. Each of the outputs may be used to generate visualizations for process monitoring and diagnostics and perform alarm diagnostics to detect abnormal situations in the process.

With this aspect of the disclosure, a coker abnormal situation prevention module 300 may be defined and applied for on-line diagnostics, which may be useful in connection with coking in coker heaters and a variety of process equipment faults or abnormal situations within a refining process plant. The model may be derived using regression modeling. In some cases, the disclosed method may be used for observing long term coking within the coker heater rather than instantaneous changes with the coker heater efficiency. For instance, the disclosed method may be used for on-line, long term collaborative diagnostics. Alternatively or additionally, the disclosed method may provide an alternative approach to regression analysis.

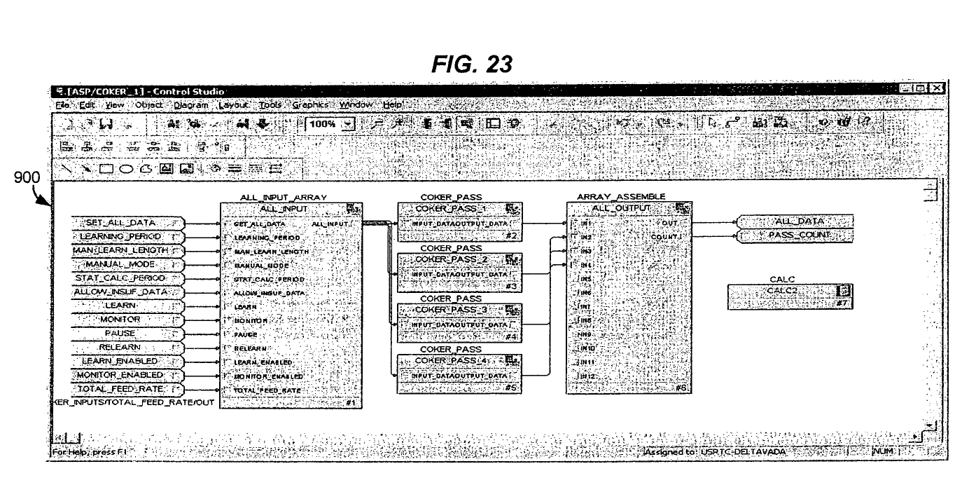

The disclosed method may be implemented in connection with a number of control system platforms, including, for instance, as illustrated in FIG. 23, DeltaV™ 900 and Ovation®, and with a variety of process equipment and devices, such as the Rosemount 3420 FF Interface Module. Alternatively, the disclosed method and system may be implemented as a stand alone abnormal situation prevention application. In either case, the disclosed method and system may be configured to generate alerts and otherwise support the regulation of coking levels in coker heaters.

The above-described examples involving abnormal situation prevention in a coker heater are disclosed with the understanding that practice of the disclosed systems, methods, and techniques is not limited to such contexts. Rather, the disclosed systems, methods, and techniques are well suited for use with any diagnostics system, application, routine, technique or procedure, including those having a different organizational structure, component arrangement, or other collection of discrete parts, units, components, or items, capable of selection for monitoring, data collection, etc. Other diagnostics systems, applications, etc., that specify the process parameters being utilized in the diagnostics may also be developed or otherwise benefit from the systems, methods, and techniques described herein. Such individual specification of the parameters may then be utilized to locate, monitor, and store the process data associated therewith. Furthermore, the disclosed systems, methods, and techniques need not be utilized solely in connection with diagnostic aspects of a process control system, particularly when such aspects have yet to be developed or are in the early stages of development. Rather, the disclosed systems, methods, and techniques are well suited for use with any elements or aspects of a process control system, process plant, or process control network, etc.

The methods, processes, procedures and techniques described herein may be implemented using any combination of hardware, firmware, and software. Thus, systems and techniques described herein may be implemented in a standard multi-purpose processor or using specifically designed hardware or firmware as desired. When implemented in software, the software may be stored in any computer readable memory such as on a magnetic disk, a laser disk, or other storage medium, in a RAM or ROM or flash memory of a computer, processor, I/O device, field device, interface device, etc. Likewise, the software may be delivered to a user or a process control system via any known or desired delivery method including, for example, on a computer readable disk or other transportable computer storage mechanism or via communication media. Communication media typically embodies computer readable instructions, data structures, program modules or other data in a modulated data signal such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Thus, the software may be delivered to a user or a process control system via a communication channel such as a telephone line, the Internet, etc. (which are viewed as being the same as or interchangeable with providing such software via a transportable storage medium).

Thus, while the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

1. A method for detecting an abnormal situation during operation of a coker heater within a process plant, the method comprising:
collecting a plurality of first data points for the coker heater while the coker heater is in a first operating region during a first period of coker heater operation, the first data points generated from a total feed rate variable and generated from at least one of a gain variable or a heat transfer variable;
generating a regression model of the coker heater in the first operating region from the first data points;
inputting a plurality of second data points into the regression model, the plurality of second data points generated from the total feed rate variable and generated from at least one of the gain variable or the heat transfer variable during a second period of coker heater operation while the coker heater is in the first operating region;
outputting, from the regression model, a predicted value generated from at least one of the gain variable or heat transfer variable as a function of a value generated from the total feed rate variable during the second period of coker heater operation;
comparing the predicted value generated from at least one of the gain variable or heat transfer variable during the second period of coker heater operation to a respective value generated from the gain variable or heat transfer variable during the second period of coker operation; and
detecting an abnormal situation if the value generated from at least one of the gain variable or heat transfer variable during the second period of coker heater operation significantly deviates from the respective predicted value generated from at least one of the gain variable or heat transfer variable.

2. The method of claim 1, wherein the plurality of first data points and the plurality of second data points comprise first data points and second data points generated from one or more of the total feed rate, a flow rate, a flow valve position, a temperature of pass matter at a position before a heating element of a conduit of the coker heater, and a temperature of pass matter at a position after the heating element of the conduit of the coker heater.

3. The method of claim 1, wherein the gain variable comprises at least one of a flow rate and a valve position.

4. The method of claim 1, wherein collecting the plurality of first data points comprises collecting at least one of the group consisting of: raw process variable data and a statistical variation of the raw process variable data.

5. The method of claim 4, wherein the statistical variation of the raw process variable data comprises one or more of a mean, a median, or a standard deviation.

6. The method of claim 5, further comprising modeling the standard deviation of the statistical variation of the process variable data as a function of a load variable.

7. The method of claim 1, further comprising generating a new regression model of the coker heater in a second operating region if a second data point generated from the total feed rate variable is observed outside the first operating region during the second period of coker heater operation.

8. The method of claim 1, wherein the coker heater comprises a plurality of conduits, each conduit comprising a flow controller in communication with a flow control valve, wherein the flow controller is configured to modify a flow valve position to control a flow rate of matter within the conduit.

9. The method of claim 8, further comprising modifying the flow valve position upon detecting an abnormal situation.

10. The method of claim 8, wherein the coker heater further comprises a heat controller in communication with a conduit heater, wherein the heat controller is configured to modify a heat output of the conduit heater to modify the temperature of flowing matter within the plurality of conduits.

11. The method of claim 10, further comprising modifying a heat output of the conduit heater to modify the temperature of the flowing matter within the conduit upon detecting an abnormal situation.

12. The method of claim 1, wherein the total feed rate variable comprises a flow rate for a pass of the coker heater.

13. The method of claim 1, wherein the gain variable is a function of one or more of the group consisting of: a rate of flow through a coker heater conduit, a position of a flow control valve, a controller output, and a controller demand.

14. The method of claim 1, wherein the heat transfer variable is a function of one or more of the group consisting of: a rate of flow through a coker heater and a change in a temperature of flowing matter in the conduit from a beginning of the conduit to an end of the conduit.

15. A method for detecting an abnormal condition during operation of a coker heater within a process plant, the coker heater including a plurality of conduits, the method comprising:
collecting, during a first period of coker heater operation, first data sets generated from a total feed rate and, for each conduit, generated from at least one of a gain and a heat transfer wherein the gain is a function of a flow rate of matter through the conduit and a position of the flow control valve, and wherein the heat transfer is a function of the flow rate of matter through the conduit and a change in a temperature of matter in the conduit from a beginning of the conduit to an end of the conduit;
generating a regression model of the coker heater in a first operating region from the first data sets, wherein the total feed rate corresponds to a load variable of the regression model and at least one of the gain and the heat transfer corresponds to a monitored variable of the regression model;
collecting, during a second period of coker heater operation, second data sets generated from the total feed rate and, for each conduit, generated from at least one of the gain and the heat transfer;
inputting into the regression model the second data sets generated from the total feed rate;
outputting from the regression model a predicted value generated from at least one of the gain and the heat transfer;
at least one of:
comparing the predicted value generated from the gain with the gain recorded during the second period of coker operation, and
comparing the predicted value generated from the heat transfer with the heat transfer recorded during the second period of coker operation; and
detecting an abnormal situation if the value generated from at least one of the gain during the second period of coker operation and the heat transfer during the second period of coker operation significantly deviates from the predicated values generated from the gain and heat transfer.

16. The method of claim 15, wherein the gain is a function of the rate of flow through the conduit and at least one of the position of a flow control valve, a controller output, or a controller demand.

17. The method of claim 16, further comprising modifying a position of the flow control valve if the value generated from the gain during the second period of coker operation significantly deviates from the predicted value generated from the gain.

18. The method of claim 15, further comprising modifying a heat output of a conduit heater if the value generated from the heat transfer during the second period of coker operation significantly deviates from the predicted value generated from the heat transfer.

19. The method of claim 15, further comprising generating a new regression model of the coker heater if data generated from the total feed rate during the second period of coker heater operation is not within the first operating region.

20. The method of claim 15, further comprising detecting an upstream location of the abnormal situation if the abnormal situation is detected for all of the plurality of conduits.

21. The method of claim 15, further comprising inputting data generated from the flow rate into the regression model to result in an output from the regression model of a predicted value generated from one or more of the gain and the heat transfer.

22. A system for monitoring an abnormal situation in a coker heater of a process plant comprising:
a data collection tool adapted to collect on-line process data from the coker heater during operation of the coker heater, wherein the collected on-line process data is generated from a plurality of coker heater process variables;
an analysis tool comprising a regression analysis engine adapted to model the operation of the coker heater based on a set of data generated from the collected on-line process data comprising a measure of the operation of the coker heater when the coker heater is on-line, wherein the model of the operation of the coker heater is adapted to be executed to generate a predicted value generated from a first one of the plurality of coker heater process variables as a function of data generated from a second one of the plurality of coker heater process variables, and wherein the analysis tool is adapted to store the model of the operation of the coker heater and the set of data generated from the collected on-line process data; and
a monitoring tool adapted to generate:
the set of data generated from the collected on-line process data,
the predicted value generated from at least one of the coker heater process variables using the analysis tool, and
a coker heater status including a parameter of the model of the operation of the coker heater, wherein the parameter of the model of the operation of the coker heater comprises the at least one process variable of the set of data generated from the collected on-line process data.

23. The system of claim 22, wherein the plurality of coker heater process variables comprises one or more of the group consisting of: a total feed rate, a conduit flow rate, a flow valve position, a temperature of pass matter at a position before a heating element of a conduit of the coker heater, and a temperature of pass matter at a position after the heating element of the conduit of the coker heater; and
wherein the parameter of the model of the operation of the coker heater comprises the total feed rate and the predicted value of the at least one of the coker heater process variables comprises one or more of the group consisting of: the conduit flow rate relative to the flow valve position, and a difference between the temperature of pass matter at the position after the heating element of the conduit of the coker heater and the temperature of pass matter at the position before the heating element of the conduit of the coker heater.

24. A system for detecting an abnormal situation in a coker heater of a process plant comprising:
a data collection tool adapted to collect on-line process data from the coker heater during operation of the coker heater, wherein the collected on-line process data is generated from a plurality of coker heater process variables;
an analysis tool comprising a regression analysis engine adapted to model the operation of the coker heater based on a set of data generated from the collected on-line process data comprising a measure of the operation of the coker heater when the coker heater is on-line, wherein the model of the operation of the coker heater is adapted to be executed to generate a predicted value generated from a first one of the plurality of coker heater process variables as a function of data generated from a second one of the plurality of coker heater process variables, and wherein the analysis tool is adapted to store the model of the operation of the coker heater and the set of data generated from the collected on-line process data;
a monitoring tool adapted to generate:
the set of data generated from the collected on-line process data,
the predicted value generated from the at least one of the coker heater process variables using the analysis tool, and
a coker heater status including a parameter of the model of the operation of the coker heater, wherein the parameter of the model of the operation of the coker heater comprises the at least one process variable of the set of data generated from the collected on-line process data;
an operator display including a representation of the coker heater having a plurality of coker heater passes;
a selectable user interface structure associated with each of the plurality of coker heater passes, each structure adapted to display information about the associated coker heater pass; and
an abnormal situation indicator including a graphical display associated with each pass of the representation of the coker heater, the graphical display adapted to indicate a an abnormal situation of the coker heater and a pass associated with the abnormal situation during operation of the coker heater.

25. The system of claim 24, wherein the selectable user interface structure is adapted to enable a user to control a configurable parameter of the coker heater, the configurable parameter including at least one of a learning mode time period, a statistical calculation period, a regression order, and a threshold limit.
